(19) United States
(12) Patent Application Publication
(10) Pub. No.: US 2024/0147263 A1
(43) Pub. Date: May 2, 2024

(54) SCHEME OF MOBILITY AND METHOD AND APPARATUS FOR THE SAME

(71) Applicant: Samsung Electronics Co., Ltd., Suwon-si (KR)

(72) Inventors: Weiwei WANG, Beijing (CN); Hong WANG, Beijing (CN); Lixiang XU, Beijing (CN)

(21) Appl. No.: 18/500,564

(22) Filed: Nov. 2, 2023

(30) Foreign Application Priority Data
Nov. 2, 2022 (CN) 202211364916.6
Feb. 3, 2023 (CN) 202310124894.4

(51) Int. Cl. H04W 24/02; H04W 56/00

(52) U.S. Cl. CPC H04W 24/02; H04W 56/0015

(57) ABSTRACT

The disclosure relates to a fifth-generation (5G) or sixth-generation (6G) communication system for supporting a higher data transmission rate. A scheme of mobility and method and apparatus for the same, and a method performed by a first node in a communication system are provided. The method includes transmitting a first message to a second node, the first message including information related to a state in which the first node is, receiving a second message from the second node, the second message including first configuration information related to signal transmission and/or reception by the first node, and transmitting and/or receiving a signal based on the first configuration information.

### CROSS-REFERENCE TO RELATED APPLICATION(S)

This application is based on and claims priority under 35 U.S.C. § 119(a) of a Chinese patent application number 202211364916.6, filed on Nov. 2, 2022, in the Chinese Intellectual Property Office, and of a Chinese patent application number 202310124894.4, filed on Feb. 3, 2023, in the Chinese Intellectual Property Office, the disclosure of each of which is incorporated by reference herein in its entirety.

### BACKGROUND

### 1. Field

The disclosure relates to a wireless communication technology. More particularly, the disclosure relates to a mobile mechanism, a method and an apparatus for the same.

### 2. Description of Related Art

Fifth-generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth-generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEG) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

How to address an interruption caused by a handover of a user equipment in a moving procedure is a problem that needs to be addressed at present.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a mobile mechanism, a method and an apparatus for the same.

Additional aspects will be set forth in part in the description which follows and, in part, will be apparent from the description, or may be learned by practice of the presented embodiments.

In accordance with an aspect of the disclosure, a method performed by a first node in a communication system is provided. The method includes transmitting a first message to a second node, the first message including information related to a state in which the first node is, receiving a second message from the second node, the second message including first configuration information related to signal transmission and/or reception by the first node, and transmitting and/or receiving a signal based on the first configuration information.

According to an embodiment of the disclosure, the information related to the state in which the first node includes at least one of information identifying that the first node is in a state in which cell/carrier frequency/node is not detected, information identifying that the first node is in a state in which a cell/carrier frequency/node is detected, information indicating that the first node is in a state in which a first downlink synchronization signal has been received, information indicating that the first node is in a state in which downlink synchronization has been completed, information indicating that the first node is in a state in which an uplink synchronization signal is transmitted, information indicating that the first node is in a state in which uplink synchronization is acquired.

According to an embodiment of the disclosure, the first configuration information related to the signal transmission and/or reception by the first node includes at least one of first configuration identity information for identifying a configuration required by the signal reception and/or transmission by the first node, first target indication information for indicating a target to which a signal received and/or transmitted by the first node belongs, first signal configuration information for indicating configuration information on a signal that the first node needs to receive and/or transmit, first signal reception and/or transmission information for indicating configuration information required by the signal reception and/or transmission by the first node, first access information for indicating a configuration used by the first node when accessing to a target cell.

According to an embodiment of the disclosure, the method further includes receiving a third message from the second node, wherein the third message includes second configuration information related to the signal transmission and/or reception by the first node, wherein the signal transmission and/or reception includes performing the signal transmission and/or reception based on the first configuration information and the second configuration information.

According to an embodiment of the disclosure, in response to the first message transmitted to the second node, a first request message, including the information related to the state in which the first node is, is transmitted from the second node to a third node, and a first response message including the first configuration information is transmitted from the third node to the second node.

According to an embodiment of the disclosure, the method further includes transmitting, to the second node and/or the third node, a first indication message indicating a cell to which the first node selects to access or accesses.

According to an embodiment of the disclosure, the first target indication information includes at least one of information related to a node to which a signal received and/or transmitted by the first node belongs, information related to a cell to which the signal received and/or transmitted by the first node belongs, indication information related to a type of the cell to which the signal received and/or transmitted by the first node belongs, and information indicating a carrier frequency where the signal received and/or transmitted by the first node is located, the first signal configuration information includes at least one of information identifying a set of configurations of the signal received and/or transmitted by the first node, information indicating a type of the signal received and/or transmitted by the first node, information indicating resources used for receiving and/or transmitting the signal, cell timing information indicating a timing offset between different cells, configuration information on beams required by the signal reception and/or transmission by the first node, information on a sequence included in the signal received and/or transmitted by the first node, information indicating a timing advance required when the first node transmits the signal, and information indicating valid time of the configuration information included in the first signal configuration information, the first signal reception and/or transmission configuration information includes at least one of information identifying a set of configurations required by the signal reception and/or transmission by the first node, information indicating a time range for the signal reception and/or transmission by first node, information indicating behaviors of the first node, information indicating a type of the signal received and/or transmitted by the first node, and information indicating a condition for the signal reception and/or transmission by the first node.

According to an embodiment of the disclosure, the second configuration information related to the signal transmission and/or reception by the first node includes at least one of related information indicating a configuration required by the signal reception and/or transmission by the first node, related information indicating a node to which the signal received and/or transmitted by the first node belongs, related information indicating a cell to which the signal received and/or transmitted by the first node belongs, information indicating a carrier frequency to which the signal received and/or transmitted by the first node belongs, information indicating a configuration of the signal received and/or transmitted by the first node, related information indicating a configuration required by a condition of the signal reception and/or transmission by the first node, information indicating beams required by the signal reception and/or transmission by the first node, and information indicating a timing advance required for transmitting an uplink signal.

According to an embodiment of the disclosure, the first message further includes at least one of related information indicating a node to which the information reported by the first node is directed, related information indicating a cell to which the information reported by the first node is directed, related information indicating a carrier frequency to which the information reported by the first node is directed, and information on a measurement result of the signal measured by the first node.

According to an embodiment of the disclosure, the first request message further includes at least one of information indicating a cell to which the signal that the first node receives and/or transmits belongs, information indicating a carrier frequency where the signal that the first node receives and/or transmits, information indicating the measurement result of the signal measured by the first node, and information indicating a state in which the first node is, the first response message includes at least one of information indicating a cell to which the signal that the first node receives and/or transmits belongs, information indicating a carrier frequency where the signal that the first node receives and/or transmits is located, information indicating configuration information of signal transmission and/or reception in a serving cell of the third node, and information indicating configuration information used when transmitting and/or receiving a signal in the serving cell of the third node.

In accordance with another aspect of the disclosure, a method performed by a second node in a communication system is provided. The method includes receiving a first message from a first node, the first message including information related to a state in which the first node is, transmitting a second message to a first node, the second message including first configuration information related to signal transmission and/or reception by the first node.

According to an embodiment of the disclosure, the information related to the state in which the first node includes at least one of information identifying that the first node is in a state in which no cell/carrier frequency/node is detected, information identifying that the first node is in a state in which a cell/carrier frequency/node is detected, information indicating that the first node is in a state in which a first downlink synchronization signal has been received, information indicating that the first node is in a state in which downlink synchronization has been completed, information indicating that the first node is in a state in which an uplink synchronization signal is transmitted, information indicating that the first node is in a state in which uplink synchronization is acquired.

According to an embodiment of the disclosure, the first configuration information related to the signal transmission and/or reception by the first node includes at least one of first configuration identity information for identifying a configuration required by the signal reception and/or transmission by the first node, first target indication information for indicating a target to which a signal received and/or transmitted by the first node belongs, first signal configuration information for indicating configuration information on a signal that the first node needs to receive and/or transmit, first signal reception and/or transmission information for indicating configuration information required by the signal reception and/or transmission by the first node, first access information for indicating a configuration used by the first node when accessing to a target cell.

According to an embodiment of the disclosure, the method further includes transmitting a third message to the first node, wherein the third message includes second configuration information related to the signal transmission and/or reception by the first node, wherein the signal transmission and/or reception includes performing the signal transmission and/or reception based on the first configuration information and the second configuration information.

According to an embodiment of the disclosure, the method further includes in response to the first message received from the first node, transmitting. to a third node, a first request message including the information related to the state in which the first node is, and receiving a first response message including the first configuration information from the third node.

According to an embodiment of the disclosure, the method further includes receiving, from the first node, a first indication message indicating a cell to which the first node selects to access or accesses.

According to an embodiment of the disclosure, the first target indication information includes at least one of information related to a node to which the signal received and/or transmitted by the first node belongs, information related to a cell to which the signal received and/or transmitted by the first node belongs, and information indicating a carrier frequency where the signal received and/or transmitted by the first node is located, the first signal configuration information includes at least one of information identifying a set of configurations for the signal received and/or transmitted by the first node, information indicating a type of the signal received and/or transmitted by the first node, information indicating resources used for receiving and/or transmitting the signal, cell timing information indicating a timing offset between different cells, configuration information on beams required by the signal reception and/or transmission by the first node, information on a sequence included in the signal received and/or transmitted by the first node, information indicating a timing advance required when the first node transmits the signal, and information indicating valid time of the configuration information included in the first signal configuration information, first signal reception and/or transmission configuration information includes at least one of information identifying a set of configurations required by the signal reception and/or transmission by the first node, information indicating a time range for the signal reception and/or transmission by the first node, information indicating behaviors of the first node, information indicating a type of the signal received and/or transmitted by the first node, and information indicating a condition for the signal reception and/or transmission by the first node.

According to an embodiment of the disclosure, the second configuration information related to the signal transmission and/or reception by the first node includes at least one of related information indicating a configuration required by the signal reception and/or transmission by the first node, related information indicating a node to which the signal received and/or transmitted by the first node belongs, related information indicating a cell to which the signal received and/or transmitted by the first node belongs, information indicating a carrier frequency to which the signal received and/or transmitted by the first node belongs, information indicating a configuration for the signal received and/or transmitted by the first node, related information indicating a configuration required by reception and/or transmission of the signal by the first node, related information indicating the configuration required by the signal reception and/or transmission by the first node, related information indicating a configuration required by a condition of the signal reception and/or transmission by the first node, information indicating beams required by the signal reception and/or transmission by the first node, and information indicating a timing advance required for transmitting an uplink signal.

According to an embodiment of the disclosure, the first message includes at least one of related information indicating a node to which the information reported by the first node is directed, related information indicating a cell to which the information reported by the first node is directed, related information indicating a carrier frequency to which the information reported by the first node is directed, and information on a measurement result of the signal measured by the first node.

According to an embodiment of the disclosure, the first request message further includes at least one of information indicating a cell to which the signal that the first node receives and/or transmits belongs, information indicating a carrier frequency where the signal that the first node receives and/or transmits is located, information indicating the measurement result of the signal measured by the first node, and information indicating a state in which the first node is, the first response message includes at least one of information indicating a cell to which the signal that the first node receives and/or transmits belongs, information indicating a carrier frequency where the signal that the first node receives and/or transmits is located, information indicating configuration information of signal transmission and/or reception in a serving cell of the third node, and information indicating configuration information used when transmitting and/or receiving a signal in the serving cell of the third node.

In accordance with another aspect of the disclosure, a method performed by a third node in a communication system is provided. The method includes receiving, from a second node, a first request message including information related to a state in which a first node is, and transmitting, to the second node, a first response message including first configuration information related to signal transmission and/or reception performed at the first node.

According to an embodiment of the disclosure, the first request message is transmitted by the second node in response to receiving the first message from the first node, and the first message includes the information related on the state in which the first node is.

According to an embodiment of the disclosure, a second message is transmitted to the first node by the second node, and the second message includes the first configuration information related to the signal transmission and/or reception performed at the first node, wherein the signal transmission and/or reception is performed by the first node based on the first configuration information.

According to an embodiment of the disclosure, a third message is transmitted to the first node by the second node, and the third message includes second configuration information related to the signal transmission and/or reception performed at the first node, wherein, based on the first configuration information and the second configuration information, the signal transmission and/or reception is performed by the first node.

According to an embodiment of the disclosure, the method further includes receiving, from the first node, a first indication message indicating a cell to which the first node selects to access or accesses.

According to an embodiment of the disclosure, the information related to the state in which the first node includes at least one of information identifying that the first node is in a state in which no cell/carrier frequency/node is detected, information identifying that the first node is in a state in which a cell/carrier frequency/node is detected, information indicating that the first node is in a state in which a first downlink synchronization signal has been received, information indicating that the first node is in a state in which downlink synchronization has been completed, information indicating that the first node is in a state in which an uplink synchronization signal is transmitted, information indicating that the first node is in a state in which uplink synchronization is acquired.

According to an embodiment of the disclosure, the first configuration information related to the signal transmission and/or reception by the first node includes at least one of first configuration identity information for identifying a configuration required by the signal reception and/or transmission by the first node, first target indication information for indicating a target to which a signal received and/or transmitted by the first node belongs, first signal configuration information for indicating configuration information on a signal that the first node needs to receive and/or transmit, first signal reception and/or transmission information for indicating configuration information required by the signal reception and/or transmission by the first node, first access information for indicating a configuration used by the first node when accessing to a target cell.

According to an embodiment of the disclosure, the first target indication information includes at least one of information related to a node to which a signal received and/or transmitted by the first node belongs, information related to a cell to which the signal received and/or transmitted by the first node belongs, and information indicating a carrier frequency where the signal received and/or transmitted by the first node is located, the first signal configuration information includes at least one of information identifying a set of configurations of the signal received and/or transmitted by the first node, information indicating a type of the signal received and/or transmitted by the first node, information indicating resources used for receiving and/or transmitting the signal, cell timing information indicating a timing offset between different cells, configuration information on beams required by the signal reception and/or transmission by the first node, information on a sequence included in the signal received and/or transmitted by the first node, information indicating a timing advance required when the first node transmits the signal, and information indicating valid time of the configuration information included in the first signal configuration information, the first signal reception and/or transmission configuration information includes at least one of information identifying a set of configurations required by the signal reception and/or transmission by the first node, information indicating a time range for the signal reception and/or transmission by first node, information indicating behaviors of the first node, information indicating a type of the signal received and/or transmitted by the first node, and information indicating a condition for the signal reception and/or transmission by the first node.

According to an embodiment of the disclosure, the second configuration information related to the signal transmission and/or reception by the first node includes at least one of related information indicating a configuration required by the signal reception and/or transmission by the first node, related information indicating a node to which the signal received and/or transmitted by the first node belongs, related information indicating a cell to which the signal received and/or transmitted by the first node belongs, information indicating a carrier frequency to which the signal received and/or transmitted by the first node belongs, information indicating a configuration of the signal received and/or transmitted by the first node, related information indicating a configuration required by a condition of the signal reception and/or transmission by the first node, information indicating beams required by the signal reception and/or transmission by the first node, and information indicating a timing advance required for transmitting an uplink signal.

According to an embodiment of the disclosure, the first message further includes at least one of related information indicating a node to which the information reported by the first node is directed, related information indicating a cell to which the information reported by the first node is directed, related information indicating a carrier frequency to which the information reported by the first node is directed, and information on a measurement result of the signal measured by the first node.

According to an embodiment of the disclosure, the first request message further includes at least one of information indicating a cell to which the signal that the first node receives and/or transmits belongs, information indicating a carrier frequency where the signal that the first node receives and/or transmits, information indicating the measurement result of the signal measured by the first node, and information indicating a state in which the first node is, the first response message includes at least one of information indicating a cell to which the signal that the first node receives and/or transmits belongs, information indicating a carrier frequency where the signal that the first node receives and/or transmits is located, information indicating configuration information of signal transmission and/or reception in a serving cell of the third node, and information indicating configuration information used when transmitting and/or receiving a signal in the serving cell of the third node.

In accordance with another aspect of the disclosure, a network node in a communication system is provided. The network node includes a transceiver configured to transmit and receive a signal, and a controller coupled with the transceiver and configured to perform operations in the methods according to various embodiments of the disclosure.

By the method and the apparatus according to the disclosure, communication continuity can be maintained during a handover.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a system architecture diagram of a system architecture evolution (SAE) according to an embodiment of the disclosure;

FIG. 2 is a schematic diagram of an initial overall architecture of 5^{th} generation (5G) according to an embodiment of the disclosure;

FIG. 3 illustrates a first flow operation according to an embodiment of the disclosure;

FIG. 4 illustrates a time range for signal reception and/or transmission according to an embodiment of the disclosure;

FIG. 5 illustrates a time period setting for signal reception and/or transmission according to an embodiment of the disclosure;

FIG. 6 illustrates a second flow operation according to an embodiment of the disclosure;

FIG. 7 illustrates a third flow operation according to an embodiment of the disclosure;

FIG. 8 illustrates a fourth flow operation according to an embodiment of the disclosure;

FIG. 9 illustrates a fifth flow operation according to an embodiment of the disclosure; and

FIG. 10 is a block diagram of a network node according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed functions, operations or components which can be used in various embodiments of the disclosure and does not limit one or more additional functions, operations, or components. The terms, such as “include” and/or “have” may be construed to denote a certain characteristic, number, step, operation, constituent element, component or a combination thereof, but may not be construed to exclude a possibility of the existence of one or more other characteristics, numbers, steps, operations, constituent elements, components or combinations thereof.

The term “or” used in various embodiments of the disclosure includes any or all of combinations of listed items. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

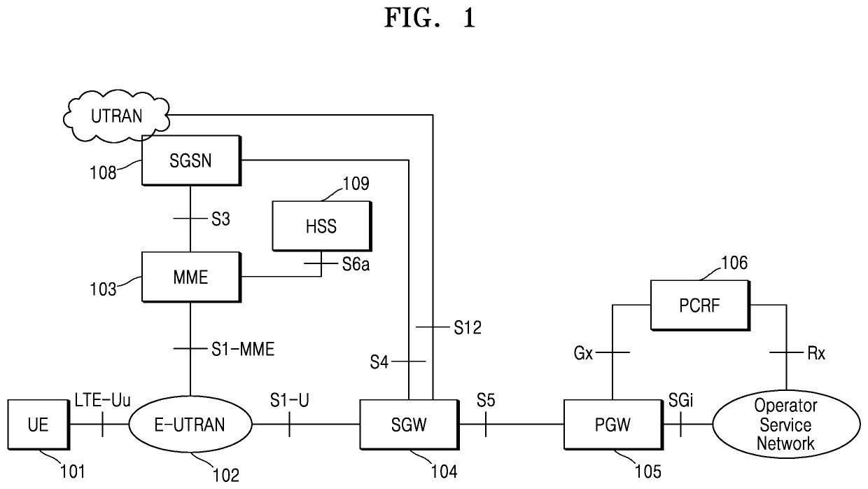

FIGS. 1 to 10 discussed below and various embodiments for describing the principles of the disclosure in the patent document are only for illustration and should not be interpreted as limiting the scope of the disclosure in any way. Those skilled in the art will understand that the principles of the disclosure can be implemented in any suitably arranged system or apparatus.

In order to meet an increasing demand for wireless data communication services since a deployment of fourth generation (4G) communication system, efforts have been made to develop an improved 5G or pre-5G communication system. Therefore, the 5G or pre-5G communication system is also called “beyond 4G network” or “post long term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data device (such as tablet computers, notebook computers, netbooks, e-book readers and machine-type device) in consumers and enterprises, a demand for wireless data services is growing rapidly. In order to meet rapid growth of mobile data services and support new applications and deployments, it is very important to improve efficiency and coverage of wireless interfaces.

In a mobile network, a user equipment will be handed over between different cells. The main problem caused by a handover is that communication for the user equipment might be interrupted during this procedure. In a future mobile network (6G), the user equipment can access to various networks. If cells employ different access technologies (such as LTE, NR, 6G, WI-FI), carrier frequencies (such as FR1, FR2, FR4, MMWave, THz, or the like) employed, and can have different coverage areas (such as terrestrial networks, non-terrestrial networks, satellite networks, high altitude platform station (HAPS), or the like) of the cells are different. When the user equipment is handed over between these different cells, more serious communication interruption for the user equipment will be caused.

FIG. 1 illustrates a system architecture 100 of system architecture evolution (SAE) according to an embodiment of the disclosure.

Referring to FIG. 1, a user equipment (UE) 101 is a terminal apparatus for receiving data. An evolved universal terrestrial radio access network (E-UTRAN) 102 is a radio access network, which includes a macro base station (eNodeB/NodeB) that provides UE with interfaces to access to the radio network. A mobility management entity (MME) 103 is responsible for managing mobility context, session context and security information on the UE. A serving gateway (SGW) 104 mainly provides functions of user plane, and the MME 103 and the SGW 104 may be in the same physical entity. A packet data network gateway (PGW) 105 is responsible for functions of charging, lawful interception, or the like, and may be in the same physical entity as the SGW 104. A policy and charging rules function entity (PCRF) 106 provides quality of service (QoS) policies and charging criteria. A general packet radio service support node (SGSN) 108 is a network node apparatus that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, or the like.

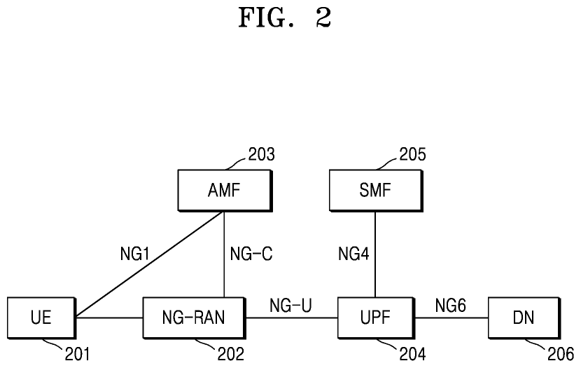

FIG. 2 is a system architecture 200 according to an embodiment of the disclosure. Other embodiments of the system architecture 200 can be used without departing from the scope of the disclosure.

Referring to FIG. 2, a user equipment (UE) 201 is a terminal apparatus for receiving data. A next generation radio access network (NG-RAN) 202 is a radio access network, which includes a base station (a gNB or an eNB connected to 5G core network 5GC, and the eNB connected to the 5GC is also referred to as ng-gNB) that provides UE with interfaces to access to the radio network. An access control and mobility management function entity (AMF) 203 is responsible for managing mobility context and security information on the UE. A user plane function entity (UPF) 204 mainly provides functions of user plane. A session management function entity SMF 205 is responsible for session management. A data network (DN) 206 includes, for example, services of operators, access of Internet and service of third parties.

Embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

Before introducing the specific contents, some assumptions and some definitions of the disclosure are provided below.

The names of messages used in the disclosure are only examples, and other names of messages can be used.

The “first”, “second” and or the like, included in the names of the messages in the disclosure are only examples of messages and do not represent any execution order.

Detailed description of steps irrelevant to the disclosure is omitted in the disclosure.

In the disclosure, the steps in respective flows can be performed in combination with each other or independently. The execution steps of each flow are only examples, and other possible execution orders are not excluded.

In the disclosure, a base station may be a 6G base station, a 5G base station (such as gNB and ng-eNB), a 4G base station (such as eNB) or other type of access node.

In the disclosure, reception of a signal can mean parsing information in the signal or measuring the signal, transmission of a signal can mean transmitting the signal for measurement at a receiving end or for analysis of the information included in the signal at the receiving end.

The nodes involved in the disclosure are:

First node: a user terminal equipment, which can be a mobile phone or a relay node;

Second node: a first base station or a first access point, which can be a source node of the first node in a moving procedure;

Third node: a second base station or a second access point, which can be a target node of the first node in a moving procedure.

The second node and the third node can be one of the following types (other types of nodes to which the user terminal can access are not excluded):

Long term evolution (LTE) base station

5G base station

6G base station

Non-terrestrial network (NTN) base station

High altitude platform station (HAPS) base station

Drone base station

Wi-Fi access point

In a moving procedure of a user equipment, the node to which the user equipment accesses will change, so it is necessary to perform a handover procedure to complete change of the access device serving the user equipment. In this procedure, the ongoing data transmission may be interrupted at the user equipment, resulting in an interruption of user service and affecting user experience. With development of the mobile communication technology, a network serving the user equipment may include many different types of access nodes (for example, the access node may be an LTE base station, a 5G base station, a 6G base station, a non-terrestrial communication base station (such as a satellite base station, an unmanned aerial vehicle base station, a hot air balloon base station, an airplane base station), and a access point of a wireless local area network). The characteristics of these nodes are quite different, such as different operating frequencies, different moving speeds, different coverage areas, and the like. If the user equipment moves in such a network, it will be handed over between various different access nodes, which will lead to more serious communication interruption in the handover procedure. Thus, an issue to be addressed is how to maintain communication continuity when the user moves between various different access nodes, and realize a short handover latency (for example, Oms).

### Schemes of Embodiments

In order to achieve a fast cell access in a handover (or a cell change) procedure, a first node needs to perform fast measurement and synchronization (including downlink synchronization and uplink synchronization) with a target cell. These measurement and synchronization are completed by receiving and/or transmitting a signal within the target cell by the first node. In order to speed up the cell handover procedure, the first node needs to measure the signal of the target cell or synchronize with the target cell in advance. The disclosure aims to configure the first node to receive and/or transmit a signal, so as to accelerate the procedure of the first node accessing to the target cell and reduce the interruption of communication.

In the disclosure, a first node will receive and/or transmit a signal in order to access to a cell. In the following description, “a signal” may include one or more of following types of the signals:

Measurement signal, which may include at least one of the following signals:

Downlink reference signal (DL reference signal), such as a cell reference signal (cell RS), a tracking reference signal (tracking RS) and a channel state information reference signal (channel state information RS);

Downlink synchronization signal, such as a synchronization signal block (SSB), a reference signal, such as a tracking reference signal, a channel state information reference signal (CSI-RS) (the CSI-RS can be used for different purposes, such as tracking, beam management, mobility, or the like), a newly defined downlink signal for synchronization (such as a fast downlink synchronization signal). The above signals may be used to perform a first downlink synchronization (a coarse synchronization) or perform a second downlink synchronization (a fine synchronization);

Uplink synchronization signal, such as a random access signal, a sounding reference signal (SRS), and a newly defined signal for uplink synchronization (such as a fast uplink synchronization signal).

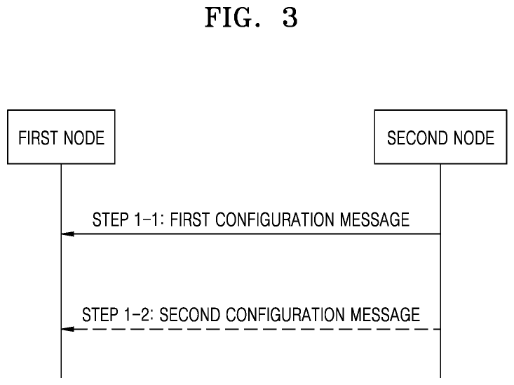

FIG. 3 provides a flowchart for configuring a first node according to an embodiment of the disclosure, which includes the following operations:

Referring to FIG. 3, in operation 1-1, the second node transmits a first configuration message to the first node, and the function of the message may include at least one of the following: 1) providing at least one candidate target node (such as a third node) or target cell, 2) providing configuration information for accessing to the target node (such as the third node) or target cell, 3) providing configuration information for measuring or monitoring the target node and/or target cell and/or a target carrier frequency, and 4) providing configuration information for receiving and/or transmitting a signal within the target cell. After receiving the message, the first node will monitor or measure the signal of the target node according to the configuration information in the message, or synchronize with the cell served by the target node, or access to the cell served by the target node. In an embodiment of the disclosure, the message can provide configuration information used by multiple target nodes (which can be candidate nodes). In another embodiment of the disclosure, the message can provide configuration information used for accessing to multiple cells (which can be candidate cells), and in another embodiment of the disclosure, the message can provide configuration information for multiple carrier frequencies (which can be candidate carrier frequencies). The advantageous effect of the message can be that the second node can configure, for first node, signal reception and/or transmission under different conditions, so that the first node accesses to a neighboring cell quickly and the interruption time in the cell handover procedure is reduced. For a node, a cell or a carrier frequency, the configuration information included in the message includes at least one of:

First configuration identity information, which identifies the configuration required for signal reception and/or transmission by the first node (the signal reception and/or transmission can have different purposes, such as signal monitoring, signal measurement, downlink synchronization, uplink synchronization, network access, or the like), and the indicated configuration can be one or more of the configuration information included in the above “first configuration message”;

First target indication information, which indicates the information on the target to which the signal received and/or transmitted by the first node belongs. This information may be generated by the second node. In an embodiment of the disclosure, the information is obtained by the second node according to the information (such as measurement information) provided by the first node, and in another embodiment of the disclosure, the information is obtained by the second node from other node (such as a third node). The information includes at least one of:

First identity information of node, which indicates the node to which the signal received and/or transmitted by the first node belongs. In an embodiment of the disclosure, the node indicated by the information is a node to which the first node may access;

First cell identity information, which indicates the cell to which the signal received and/or transmitted by the first node belongs. In an embodiment of the disclosure, the information identifies a cell which does not serve the first node. In an embodiment of the disclosure, the cell identified by the information may be a cell (a candidate target cell) to which the first node will access. Further, the cell identified by the information may be a cell in which the first node performs the signal reception and/or transmission.

Indication information on a type of cell, which indicates a type of the cell indicated by the above “first cell identity information”. The indicated type can be a cell which belongs to different distributed units (Dus) from the current serving cell of the first node (such as an inter-DU cell) or a cell which belongs to the same DU as the current serving cell of the first node (such as an intra-DU cell). After receiving this information, the first node can determine the signal reception and/or transmission according to the type of the cell. In an example, after the first node transmits a random access preamble signal to the cell indicated by the above “first cell identity information”, if the cell is an inter-DU cell, the first node does not need to wait for synchronization information (such as RACH Response information, timing advance information, or the like). And if it is an Intra-DU cell, the first node can wait for synchronization information (such as RACH Response information, timing advance information, or the like). In another example, after the first node transmits the random access preamble signal to the cell indicated by the above “first cell identity information”, if the cell is an intra-DU cell, the first node does not need to wait for synchronization information (such as RACH Response information, timing advance information, or the like). If it is an Inter-DU cell, the first node can wait for synchronization information (such as RACH Response information, timing advance information, or the like);

First indication information on carrier frequency, which indicates the carrier frequency where the signal received and/or transmitted by the first node is located. In an embodiment of the disclosure, the information indicates information on the carrier frequency where a serving cell (a candidate target cell) of the node, to which the first node may access, is located. The “serving cell (a candidate target cell) of the node, to which the first node may access” may be a cell to which the first node will access, and further, the carrier frequency identified by the information may be a carrier frequency where the first node receives and/or transmits a signal. This information may include at least one of: indication information on a location of a central carrier frequency and indication information on a frequency band range;

The configuration information in the first configuration message may be provided for different nodes, different carrier frequencies or different cells, respectively.

First configuration information on signal, which indicates configuration information on a signal which the first node needs to receive and/or transmit. Further, the signal indicated by the information may be a signal in the cell indicated by the above “first cell identity information”, or the signal indicated by the information may be a signal in the cell at the carrier frequency indicated by the above “first indication information on carrier frequency”. The advantageous effect of the information is that the first node can receive and/or transmit a corresponding first signal according to the configuration, thus the time taken by the first node to perform the signal reception and/or transmission is reduced. In an embodiment of the disclosure, the first signal can be a signal that the first node measures or monitors. In another embodiment of the disclosure, the first signal is a signal for downlink synchronization performed by the first node. In another embodiment of the disclosure, the first signal is a signal for uplink synchronization performed by the first node. In an embodiment of the disclosure, the first signal can be at least one or more of a measurement signal, a downlink synchronization signal and an uplink synchronization signal. The “first configuration information on signal” may include configuration information on one or more signals. For one signal, the information includes at least one of:

First signal configuration identity information, which identifies a set of configurations of signals received and/or transmitted by the first node;

First indication information on a type of a signal, which indicates the type of the signal received and/or transmitted by the first node, and the type of the signal indicated by this information can be referred to the above description of “signal”;

First resource information, which indicates resources used for receiving and/or transmitting a signal. In an embodiment of the disclosure, if the transmitted signal is a random access signal, the information may be indication information for indicating an occasion of transmitting the random access signal, such as a RACH Occasion Index and a physical RACH (PRACH) Mask Index. The information includes at least one of:

First frequency domain resource information, which indicates a frequency domain location where the signal is located. In an embodiment of the disclosure, the location can be indicated by a carrier frequency and a bandwidth. In another embodiment of the disclosure, the location can be indicated by an identity of a frequency domain resource, such as an identity of a range of the frequency domain resource. In another embodiment of the disclosure, the location can be indicated by an identity of a frequency band, such as an identity of a Band Width Part (BWP), an identity of a sub-band. In another embodiment of the disclosure, the location can be determined by a location relative to other signal (such as a frequency domain offset). For example, when the “first frequency domain resource information” is used to indicate a location of the uplink synchronization signal, the “first frequency domain resource information” can be used to indicate a location relative to the downlink synchronization signal. For example, when the “first frequency domain resource information” is used to indicate a location of the downlink synchronization signal, the “first frequency domain resource information” can be used to indicate a location relative to the measurement signal or a location relative to the uplink synchronization signal;

First time domain resource information, which indicates a time domain location where the signal is located. In order to indicate the location, the information may include at least one of:

Period;

Offset;

Number of a time unit (such as the number of a time slot and the number of a symbol);

Time length;

Starting time, which indicates a time for starting to transmit the first signal or a time for starting to receive the first signal;

Signal relative location information, which can be used to indicate a location relative to other signal (such as a frequency domain offset). For example, when the “signal relative location information” is used to indicate a location of the uplink synchronization signal, it can be used to indicate a location relative to the downlink synchronization signal. For example, when the “signal relative location information” is used to indicate a location of the downlink synchronization signal, it can be used to indicate a location relative to the measurement signal or a location relative to the uplink synchronization signal.

First cell timing information, which may indicate an offset of timing between different cells (such as an offset of a system frame number), the offset may be relative to the current serving cell of the user equipment;

First beam configuration information, which indicates a beam required by the signal reception and/or transmission, and may include at least one of: indication information on transmission configuration indicator (TCI) state, identity information on the beam, precoding information on Rx beams, precoding information on Tx beams, indication information on associated SSBs, or the like;

First sequence information, which indicates a sequence included in the signal received and/or transmitted by the first node. In an embodiment of the disclosure, if the signal transmitted by the first node is a random access signal (such as an random access preamble), the information may indicate the sequence of the transmitted signal, such as a preamble Index;

First timing advance information, which indicates a timing advance required by the first node when transmitting a signal, and can help the first node to quickly complete the uplink synchronization. In an embodiment of the disclosure, the information is generated by the second node, and in another embodiment of the disclosure, the information is obtained by the second node from other nodes;

First valid time information, which indicates a valid time of the configuration information included in the above “first configuration information on signal”. If the valid time expires, the configuration information will no longer be valid, and the first node cannot use the configuration information to receive and/or transmit the signal;

First configuration information on signal reception and/transmission, which indicates the configuration information required by the signal reception and/transmission by the first node. The advantageous effect of the information is that the first node can receive and/or transmit the signal according to the information, thus avoiding unnecessary signal discovery procedure or interference caused by the signal transmission of the first node. In an embodiment of the disclosure, the information may be provided for different objectives (such as nodes, cells and carrier frequencies) indicated by the above “first target indication information”, respectively. In another embodiment of the disclosure, the information may be collective configuration information provided for different objectives (such as nodes, cells, and carrier frequencies) indicated by the above “first target indication information”. The information includes at least one of:

First identity information on signal reception and/transmission configuration, which identifies a set of configurations required by the signal reception and/transmission by the first node;

First indication information on reception and/transmission time, which indicates a time range of the signal reception and/transmission by the first node. This information can be named as measurement gap, accessing gap, transmission/reception period, and the like. Further, the information will be different as the type of the signal that the first node needs to receive and/or transmit is different, or as the condition which the first node satisfies is different. The information includes at least one of:

Period;

Offset;

Number of a time unit (such as the number of a time slot and the number of a symbol);

Time length, which indicates the time length for the first node to receive and/or transmit the signal. In an embodiment of the disclosure, this length can be represented in a time unit, such as milliseconds, microseconds, seconds, or the like. In another embodiment of the disclosure, the time length can be represented in the number of symbols;

Starting time, which indicates a time when the first node starts the signal reception and/or transmission;

First indication information on behavior, which indicates the behavior of the first node. After receiving the information, the first node will perform the signal reception and/transmission according to the indication of the information. This information may indicate at least one of the following behaviors: 1) signal measurement, 2) downlink synchronization, 3) downlink first synchronization (only monitoring or receiving a signal used for the downlink first synchronization, such as a synchronization signal block (SSB), a primary synchronization signal (PSS), a secondary synchronization signal (SSS), or the like), 4) downlink second synchronization (monitoring or receiving a signal for the downlink second synchronization, such as a cell reference signal (CRS) and a tracking reference signal (TRS), or the like), 5) uplink synchronization (such as transmitting an uplink preamble signal and obtaining a timing advance), 6) acquiring the timing advance (this behavior occurs after the first node has transmitted the uplink synchronization signal, such as the random access preamble signal), 7) uplink and downlink synchronization, and 8) storing/retaining (downlink, uplink, or downlink and uplink) synchronization information (or quasi co-location (QCL) attribute information on the reference signal) of the cell. Further, the information can indicate the behavior within the time range indicated by the above “first indication information on reception and/or transmission time”. The advantageous effect of the information is that the first node can determine the signal which is required to receive and/or transmit according to the information, thus avoiding the first node from performing reception and/or transmission of unnecessary signals and reducing the time required for the signal reception and/or transmission;

First indication information on signal, which indicates a type of the signal received and/or transmitted by the first node, and the type of the signal indicated by the information can be referred to the above description of “signal”. Further, the information may indicate a signal received and/or transmitted within the time range indicated by the above “first reception and/or transmission time information”. The advantageous effect of the information is that the first node can determine the signal which is required to receive and/or transmit according to the information, thus avoiding the first node from performing reception and/or transmission of unnecessary signals and reducing the time required for the signal reception and/or transmission;

First condition indication information, which indicates condition information on the signal reception and/transmission by the first node, and indicates the condition that the first node needs to satisfy for receiving and/or transmitting the signal indicated by other information included in the “first configuration message”. The advantageous effect of the information is that the first node can receive and/or transmit the signal according to the information, thus avoiding unnecessary signal discovery procedure or interference caused by transmitting the signal at the first node. The information includes at least one of:

First condition identity information, which identifies one of the conditions for the first node to receive and/or transmit the signal (at least one of the following conditions 1 to 6);

First threshold, which indicates a condition for the first node receiving and/or transmitting a signal (condition 1), that is, measurement result of the signal of a serving cell exceeding the first threshold, and the measurement result can be a reference signal reception power (RSRP) of Layer 3, a reference signal reception quality (RSRQ) of layer 3, a signal to interference plus noise ratio (SINR) of layer 3, an RSRP of layer 1, an RSRQ of Layer 1, a SINR of Layer 1, or a channel quality indicator (CQI);

Second threshold, which indicates a condition for the first node receiving and/or transmitting a signal (condition 2), that is, the difference between the measurement result of the signal of the serving cell (which is a cell serving the first node, or a primary cell serving the first node, or a special primary cell serving the first node) and the measurement result of the signal of other cell (which may be a cell to which the signal indicated by the above “first configuration information on signal” belongs, and may be different from the above serving cells) is less than the second threshold, and the measurement result may be an RSRP of Layer 3, an RSRQ of Layer 3, a SINR of Layer 3, an RSRP of Layer 1, an RSRQ of Layer 1, a SINR of Layer 1 or a CQI;

Third threshold and/or fourth threshold, which indicates a condition for the first node receiving and/or transmitting a signal (condition 3), that is, the measurement result of the signal of the serving cell (which is a cell serving the first node, or a primary cell serving the first node, or a special primary cell serving the first node) is less than the third threshold, and/or the measurement result of the signal of another cell (which may be a cell to which the signal indicated by the above “first configuration information on signal” belongs, and may be different from the above serving cells) is more than the fourth threshold;

First state indication information, which indicates a condition for the first node receiving and/or transmitting a signal (condition 4), that is, the state in which the first node is. In an embodiment of the disclosure, the state is a state in which the first node is required to be when it starts to receive and/or transmit a signal indicated by other information included in the above “First Configuration Message”. The information may indicate at least one of the following states:

No cell/node/carrier frequency detected, in an embodiment of the disclosure, which indicates that the first node has not detected the configured cell/node/carrier frequency;

Cell(s)/node(s)/carrier frequency(s) detected;

No downlink synchronization, which indicates that the first node has not acquired the downlink synchronization;

Downlink first synchronization, in an embodiment of the disclosure, which indicates that the first node has received the downlink first synchronization signal (such as an SSB, a PSS/SSS) and completed the downlink coarse synchronization;

Downlink synchronization, in an embodiment of the disclosure, which indicates that the first node has received the downlink second synchronization signal (such as a cell reference signal, a tracking reference signal). In another embodiment of the disclosure, which indicates that the first node has received the downlink first synchronization signal and the downlink second synchronization signal;

Transmission of an uplink random access signal. If a base station receives the random access signal, the base station will generate a configuration (such as timing advance information) to help the first node to perform the uplink synchronization. In an embodiment of the disclosure, the state indicates that the first node has transmitted a random access preamble. In another embodiment of the disclosure, the state indicates that the first node has transmitted an SRS signal, and in another embodiment of the disclosure, the state indicates that the first node has transmitted a newly defined signal for user uplink synchronization;

Uplink synchronization, in an embodiment of the disclosure, which indicates that the first node has completed the uplink synchronization with other cell which is different from the cell serving the first node (or the primary cell, or the special primary cell);

Uplink and downlink synchronization, in an embodiment of the disclosure, which indicates that the first node has completed the uplink and downlink synchronization with other cell which is different from the cell serving the first node (or the primary cell, or the special primary cell));

First duration length information, which indicates a condition for the first node receiving and/or transmitting a signal (condition 5), that is, the duration required by the first node to satisfy at least one of the above conditions 1 to 4. In order to indicate the condition, the above “first condition indication information” may include the first duration information;

First counting information, which indicates a condition for the first node receiving and/or transmitting a signal (condition 6), that is, the required number of times that the first node satisfies at least one of the above conditions 1 to 4;

Fifth threshold information, which indicates a threshold of the first node retaining/storing the (downlink, uplink, or downlink and uplink) synchronization information (or quasi co-location (QCL) attribute information on a reference signal) of a cell. In an example, the threshold can be a threshold of the measurement result of the cell. For example, when the measurement result of the cell is greater than the threshold, the first node can retain/store the (downlink, uplink, or downlink and uplink) synchronization information (or quasi co-location (QCL) attribute information on the reference signal) of the cell after downlink synchronization with the cell. In another example, the threshold can be a threshold of the number of the cells, e.g., the threshold of the number of the cells of which the (downlink, uplink, or downlink and uplink) synchronization information (or quasi co-location (QCL) attribute information on the reference signal) is retained/stored at the first node (for example, the threshold can be determined based on user capability). When the number of the cells of which the (downlink, uplink, or downlink and uplink) synchronization information (or quasi co-location (QCL) attribute information on the reference signal) is retained at the first node is less than the threshold, the first node can retain the (downlink, uplink, or downlink and uplink) synchronization information (or quasi co-location (QCL) attribute information on the reference signal) of more cells. In another example, the threshold includes multiple thresholds, such as the threshold of the measurement result of the cell and the threshold of the number of the cells. For example, when the measurement result of the cell is greater than the threshold, and when the number of the cells of which the (downlink, uplink, or downlink and uplink) synchronization information (or quasi co-location (QCL) attribute information on the reference signal) has been retained at the first node satisfies the capacity requirements of the first node (if the threshold of the number of the cells is not exceeded), the first node can retain the (downlink, uplink, or downlink and uplink) synchronization information (or quasi co-location (QCL) attribute information on the reference signal) of the cell after (downlink, uplink, or downlink and uplink) synchronization with the cell. The above measurement result can be an RSRP of Layer 3, an RSRQ of Layer 3, a SINR of Layer 3, an RSRP of Layer 1, an RSRQ of Layer 1, a SINR of Layer 1 and a CQI. The cell to which the above measurement result is directed, or the cell to which the retained (downlink, uplink, or downlink and uplink) synchronization information (or quasi co-location (QCL) attribute information on the reference signal) is directed may be the cell indicated by the above “first target indication information”;

Further, the above “first indication information on reception and/or transmission time”, “first indication information on behavior”, “first indication information on signal” and “first condition indication information” are interrelated, for example, the setting in one piece of information is determined by the setting in another or more pieces of information. For example, at least one of the above “first indication information on behavior”, “first indication information on signal” and “first condition indication information” determines the configuration in the above “first indication information on reception and/or transmission time”.

First access configuration information, which is the configuration used by the first node when accessing to the target cell, and may include the configuration for a random access (such as a resource configuration of a non-contention based random access, and a resource configuration of a contention based random access). For details, please refer to the configuration in RRCReconfiguration.

After the first node receives the above first configuration message, in an embodiment of the disclosure, the first node will start to receive and/or transmit the signal according to the configuration information in the message. In another embodiment of the disclosure, the first node will store the configuration information in the message. As for the time for starting the signal reception and/or transmission, it is required that after the above “first condition indication information” is satisfied, the signal reception and/or transmission is started. In another embodiment of the disclosure, the first node will store the configuration information in the message. As for the time for starting the signal reception and/or transmission, it is required to receive further indication information from the second node.

After receiving the above first configuration message, the first node can perform the signal reception and/or transmission according to the configuration information. According to different configurations, the first node has different behaviors. Several possible embodiments are provided below.

Signal reception and/or transmission or access to the target cell within a time period indicated by the “first indication information on reception and/or transmission time”

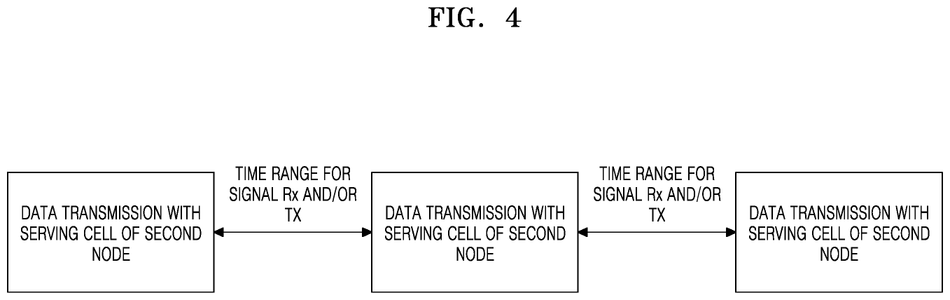

FIG. 4 illustrates a time range for signal reception and/or transmission according to an embodiment of the disclosure.

Referring to FIG. 4, the time period indicated by the “first indication information on reception and/or transmission time” may be discontinuous. The first node may continue to maintain data communication with the second node during the time outside the time period, as illustrated in FIG. 4. The length of the time period will be different due to the different “first indication information on behavior” and/or “first indication information on signal” and/or “first condition indication information”. During the time period, the first node may have different behaviors based on the configuration. When the above “first indication information on behavior” indicates the first node to perform the uplink synchronization, or the uplink and downlink synchronization, or the synchronization or the cell access, the first node will perform the cell access or the signal reception and/or transmission based on the configuration in the “first configuration information on signal” and/or the configuration in the “first access configuration information”. In an implementation, the second node configures a measurement gap for the first node, which indicates the first node to perform the uplink synchronization, or the uplink and downlink synchronization, or the synchronization, or the cell access, then the first node will access to the target cell according to the configuration in the “first configuration information on signal” and/or the configuration of the random access in the “first access configuration information”. Further, if a downlink synchronization signal (such as a fast downlink synchronization signal) and an uplink synchronization signal (such as a fast uplink synchronization signal) are also configured, the first node will perform the downlink synchronization first and then the uplink and downlink synchronization, or perform the uplink synchronization first and then the downlink synchronization, according to the configuration. Furthermore, if the first node cannot complete the synchronization within one time period, the first node will complete the synchronization during multiple time periods (the multiple time periods are also provided by the configuration in the “first configuration information on signal” and/or the “first access configuration information”, and every two time periods in the multiple time periods may have a gap time between them, and the first node can communicate data with the second node during the gap time).

Determining whether to perform the signal reception and/or transmission according to the configuration of the “first condition indication information”

When the condition(s) indicated in the first condition indication information are satisfied, the first node will perform the cell access or the signal reception and/or transmission, or retain the (downlink, uplink, or downlink and uplink) synchronization information (or quasi co-location (QCL) attribute information on the reference signal) of the cell according to the configuration in the “first configuration information on signal” and/or the configuration in the “first configuration information on signal reception and/or transmission”. Moreover, in the above operation 1-1, different conditions (conditions indicated by the above “first condition indication information”) will also correspond to different “first configuration information on signal” and/or the “first configuration information on signal reception and/or transmission”. In addition, the above “first condition indication information” is associated with the configuration in the above “first configuration information on signal” and/or the “first configuration information on signal reception and/or transmission”. Even as for receiving and/or transmitting the same signal, the conditions which the first node satisfies are different, it will cause that the first node uses different “first configuration information on signal” and/or different “first configuration information on signal reception and/or transmission”. For example, the time taken by the first node to perform the signal reception and/or transmission will be different if the first node is in different states. As another example, the signals received and/or transmitted by the first node are different if the first node is in different states.

In an implementation, the above first configuration message is a control plane message, such as a radio resource control (RRC) message (an RRC reconfiguration message). In another implementation, the above first configuration message is a message of the second protocol layer, such as a message of the L2 layer (such as a control element of the medium access control (MAC) layer). In another implementation, the above first configuration message is a message of the first protocol layer, such as a message of the L1 layer (such as a message of the physical layer, downlink control information, or the like).

Optionally, after operation 1-1, the second node may transmit to the first node the configuration which is required by the first node to receive and/or transmit a signal, and the indicated configuration

n is configured through operation 1-1 in advance, that is:

Operation 1-2: The second node transmits, to the first node, a first indication message (or a second configuration message), indicating the first node to receive and/or transmit the signal. The first node can be configured with the configuration of the signal received and/or transmitted, by the second node in advance, such as through the above operation 1-1. In addition, the first indication message can also be used to indicate the first node to perform a cell handover (or cell change). The advantageous effect of the message is that the first node can quickly start and complete the reception and/or transmission of the signal, and reduce the interruption from the cell currently serving the first node. The message includes at least one of:

Second configuration identity information, which indicates a configuration required by the signal reception and/or transmission by the first node, and the configuration may be configured for the first node in advance, such as through the above operation 1-1. In an embodiment of the disclosure, the configuration identified by the identity information is the configuration represented by the “first configuration identity information” in operation 1-1;

Second configuration indication information, which indicates an identity of the configuration required by the signal reception and/or transmission by the first node, and the indication information may be index information on the identity of the configuration. The configuration represented by the identity may be configured for the first node in advance, such as through the above operation 1-1. In an embodiment of the disclosure, the identity of the configuration indicated by the indication information is the “first configuration identity information” in the above operation 1-1;

Second identity information of node, which indicates a node to which the signal received and/or transmitted by the first node belongs;

Second identity indication information of node, which indicates an identity of the node to which the signal received and/or transmitted by the first node belongs, and the indication information may be index information on the identity of the node. The identity of the node may be configured for the first node in advance, such as through the “first identity information of node” in the above operation 1-1;

Second cell identity information, which indicates a cell to which the signal received and/or transmitted by the first node belongs. Further, the information can also indicate the cell to which the first node needs to access;

Second cell identity indication information, which indicates an identity of the cell to which the signal received and/or transmitted by the first node belongs, and the indication information may be index information on the identity of the cell. The identity of the cell can be configured for the first node in advance, such as through the “first cell identity information” in the above operation 1-1. Further, the information can also indicate the cell to which the first node needs to access;

Second indication information on carrier frequency, which indicates a carrier frequency to which the signal received and/or transmitted by the first node belongs, and this carrier frequency may be configured for the first node in advance, such as the “first indication information on carrier frequency” in the above operation 1-1;

Second signal configuration identity information, which indicates a configuration of the signal which the first node needs to receive and/or transmit. The configuration may be configured for the first node in advance, such as through the above operation 1-1. In an embodiment of the disclosure, the configuration identified by the identity information is the configuration represented by the “first signal configuration identity information” in operation 1-1;

Second signal configuration indication information, which indicates an identity of the configuration of the signal which the first node needs to receive and/or transmit, and the indication information may be index information on the identity of the configuration. The identity of this configuration may be transmitted to the first node in advance, such as through the above operation 1-1. In an embodiment of the disclosure, the identity of the configuration indicated by the indication information is the “first signal configuration identity information” in the above operation 1-1. In an embodiment of the disclosure, if the transmitted signal is a random access signal, the information may be indication information for indicating an occasion of transmitting the random access signal, such as a PRACH Occasion Index, a PRACH Mask Index. In another embodiment of the disclosure, the indication information may indicate a set of multiple different configurations. For example, if the signal transmitted by the first node is a random access signal, the indication information may indicate the occasion of transmitting the random access signal (such as a RACH occasion Index, a PRACH Mask Index), a sequence of the random access signal (such as a preamble Index), and the associated beam (such as SSB Index);

Second identity information on signal reception and/or transmission configuration, which indicates a configuration required by the first node for the signal reception and/or transmission, and the configuration may be configured for the first node in advance, such through the above operation 1-1. In an embodiment of the disclosure, the configuration identified by the identity information is the configuration represented by “first identity information on signal reception and/or transmission configuration” in operation 1-1;

Second indication information on signal reception and/or transmission configuration, which indicates an identity of the configuration required by the first node for the signal reception and/or transmission, and the indication information may be index information on the identity of the configuration. The identity of this configuration may be transmitted to the first node in advance, such as through the above operation 1-1. In an embodiment of the disclosure, the configuration indicated by the indication information is the configuration represented by the “first identity information on signal reception and/or transmission configuration” in operation 1-1 above;

Second condition identity information, which indicates a configuration required by the conditions for the first node receiving and/or transmitting a signal, and the configuration required by the conditions may be configured for the first node in advance, such as through the above operation 1-1. In an embodiment of the disclosure, the configuration required by the condition identified by the identity information is the configuration required by the condition represented by the “first condition identity information” in operation 1-1;

Second condition identity indication information, which indicates an identity of the configuration required by the conditions for the first node receiving and/or transmitting a signal, and the indication information may be the index information on the identity of the configuration. The configuration indicated by the identity may be transmitted to the first node in advance, such as through the above operation 1-1. In an embodiment of the disclosure, the identity indicated by the indication information is the “first condition identity information” in operation 1-1;

Second beam indication information, which indicates a beam required by the first node to receive and/or transmit a signal, such as a transmission configuration indicator (TCI), a beam identity, indication information on the associated SSB (SSB index), or the like;

Second sequence information, which indicates a sequence included in the signal received and/or transmitted by the first node. In an embodiment of the disclosure, if the signal transmitted by the first node is a random access signal (such as a random access preamble), the information may indicate a sequence of the transmitted signal, such as a preamble index;

Second timing advance information, which indicates the timing advance required for transmitting an uplink signal, and can help the first node to acquire the uplink synchronization;

Synchronization acquisition indication information, which indicates whether the first node needs to acquire synchronization information, such as uplink synchronization information. In an embodiment of the disclosure, the information indicates whether the first node needs to receive feedback information (such as RACH response information, timing advance information, or the like) from the network side after transmitting the uplink random access preamble signal. In an example, the indication information can be implicitly indicated by a type of a candidate cell (such as the type indicated by the “cell type indication information” in the first configuration message in operation 1-1). For example, after the first node transmits the random access preamble signal to the cell indicated by the above “second cell identity information”, if the cell is an inter-DU cell, the first node does not need to wait for the synchronization information (such as RACH Response information, Timing advance information, or the like), and if it is an intra-DU cell, the first node can wait for the synchronization information (such as RACH Response information, timing advance information, or the like). In another example, after the first node transmits the random access preamble signal to the cell indicated by the “second cell identity information”, if the cell is an intra-DU cell, the first node does not need to wait for the synchronization information (such as RACH response information, timing advance information, or the like), and if it is an Inter-DU cell, the first node can wait for the synchronization information (such as RACH Response information, timing advance information, or the like);

When the first node receives the second configuration message (or the first indication message), it will perform the signal reception and/or transmission according to the information included in the message. If the configuration information on the signal reception and/or transmission has been configured for the first node in advance (e.g. through operation 1-1), the first node will acquire the configuration information on the signal reception and/or transmission from the above pre-configuration according to the information included in the second configuration message. In another implementation, the above second configuration message (or the first indication message) can also be used to indicate the first node to handover to a neighboring cell/node/frequency band, and the indication information can be obtained through the above “second identity information of node” and/or the “second identity indication information of node” and/or the “second cell identity information” and/or the “second cell identity indication information” and/or “second indication information on carrier frequency”. In another embodiment of the disclosure, the above second configuration message (or the first indication message) can be used to indicate the first node to perform the uplink synchronization with a neighboring cell (or a candidate cell), such as triggering the first node to transmit a random access signal (such as a random access triggered by the physical downlink control channel (PDCCH)) to the neighboring cell (or the candidate cell).

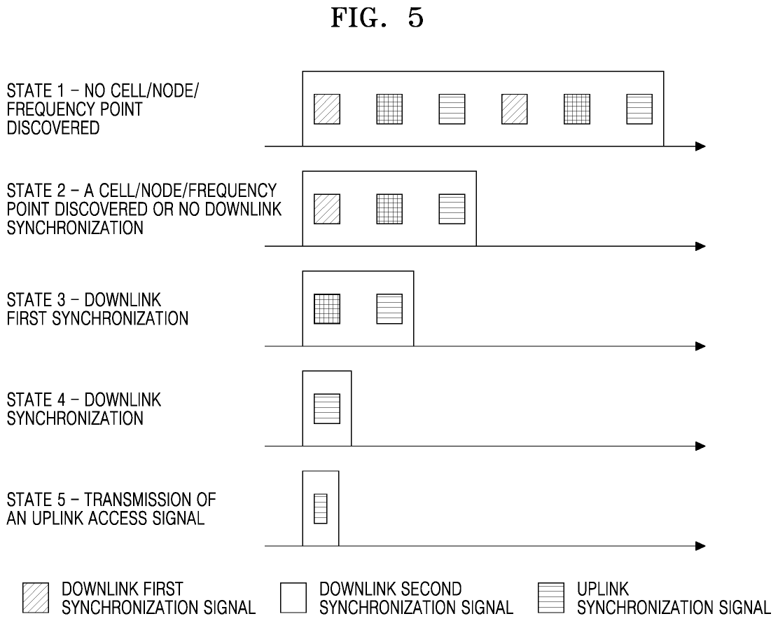

In the above operations 1-1 and 1-2, the different states of the first node will lead to different configurations. The possible configurations in different states are provided as follows (these are only examples, and the combination of other states and configurations are not excluded, such configurations may be generated by the second node, or may be acquired by the second node through the following operations 1-0a and 1-0b), as illustrated in FIG. 5:

FIG. 5 illustrates a time period setting for signal reception and/or transmission according to an embodiment of the disclosure.

Referring to FIG. 5, in state 1—no cell/node/carrier frequency detected: in this state, the user equipment has not detected a cell/node/carrier frequency in the procedure of a cell search, so the second node will be configured with a long time for the signal reception and/or transmission, as indicated by the above “first indication information on reception and/or transmission time”. Further, when the signal is configured for reception and/or transmission, the second node will configure the downlink synchronization information and the uplink synchronization information, which can help the first node to discover the cell/node/carrier frequency. Optionally, the time domain location of transmitting the signal (which can be an existing signal or a newly defined signal) required by the uplink synchronization can be configured to be closer to the time domain location of transmitting the signal (which can be an existing signal or a newly defined signal) required by the downlink synchronization of the user;

State 2—a cell/node/carrier frequency detected or no downlink synchronization: in this state, the user equipment has searched the cell/node/carrier frequency, and the second node will also be configured with a long time for the reception and/or transmission (but the time configured in this state will be slightly shorter than that in State 1), as indicated by the above “first indication information on reception and/or transmission time”. Further, when the signal is configured for reception and/or transmission, the second node will configure the information on the downlink synchronization and the uplink synchronization which can be performed within the configured time range (such as the time range indicated in the above “first indication information on reception and/or transmission time”). Optionally, the time domain location of transmitting the signal (which can be an existing signal or a newly defined signal) required by the uplink synchronization can be configured to be closer to the time domain location of transmitting the signal (which can be an existing signal or a newly defined signal) required by the downlink synchronization for the user;

State 3—downlink first synchronization (or retaining downlink synchronization information (or quasi co-location(QCL) attribute information on reference signal), which was obtained through the SSB): when the signal is configured for reception and/or transmission, the second node will configure information on the downlink second synchronization information and the uplink synchronization, which can be performed within the configured time range (such as indicated in the above “first indication information on reception and/or transmission time”). Optionally, the time domain location of transmitting the signal (which can be an existing signal or a newly defined signal) required by the uplink synchronization can be configured to be closer to the time domain location of transmitting the signal (which can be an existing signal or a newly defined signal) required by the downlink second synchronization for the user;

State 4—downlink synchronization (or retaining downlink synchronization information (or quasi co-location (QCL) attribute information on reference signal)): when the signal is configured for reception and/or transmission, the second node will configure information on the uplink synchronization, which can be carried out within the configured time range (such as indicated in the above “first indication information on reception and/or transmission time”). For example, the first node transmits the uplink synchronization signal (such as a random access preamble signal), and then receives the timing advance for the uplink synchronization;

State 5—transmitting uplink access signal: the second node will configure a short time for the signal reception and/or transmission, as indicated by the above “first indication information on reception and/or transmission time”. In an example, the uplink access signal may be a random access signal. In another example, it may be an SRS signal. In yet another example, it may be a newly defined uplink signal. Further, the first node can acquire timing advance information within the time indicated in the above “first indication information on reception and/or transmission time” (in the procedure of uplink synchronization, the first node will first transmit an uplink access signal and then receive timing advance information transmitted by the base station. In the above state 5, the first node has already transmitted the uplink access signal, so the second node can configure a shorter time for the first node to acquire the timing advance information).

In an implementation, the second configuration message (or the first indication message) is a control plane message, such as an RRC message (an RRC Reconfiguration message). In another embodiment of the disclosure, the second configuration message (or the first indication message) is a message of the second protocol layer, such as a message of L2 layer (such as a control element of the MAC layer). In another implementation, the second configuration message (or the first indication message) is a message of the first protocol layer, such as a message of L1 layer (such as a message of the physical layer, downlink control information, or the like). If it is downlink control information, the above operations 1-2 may be a random access triggered by the PDCCH.

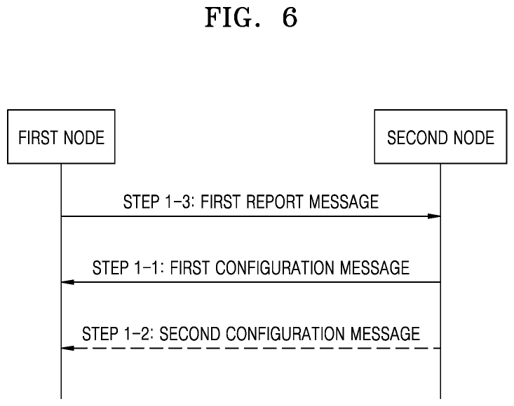

Optionally, the above operations 1-1 and 1-2 may be triggered based on information transmitted by the first node, as illustrated in FIG. 6, i.e.,

FIG. 6 illustrates a second flow operation according to an embodiment of the disclosure.

Referring to FIG. 6, in operation 1-3, the first node transmits a first report message to the second node, the first report message includes information obtained by the signal reception and/or transmission by the first node. The advantageous effect of the message is that the second node can obtain the state of the signal received and/or transmitted by the first node, thereby determining the configuration required by the first node to handover to other cell, and reducing the time taken by the first node to access to other cell. The first report message contains at least one of:

Third identity information of node, which indicates a node to which the information reported by the first node is directed. In an embodiment of the disclosure, the node indicated by the information is a node to which the first node may access;

Third cell identity information, which indicates a cell to which the information reported by the first node is directed. In an embodiment of the disclosure, the information identifies a cell that does not serve the first node. In an embodiment of the disclosure, the cell identified by the information may be a cell to which the first node will access (a candidate target cell). Further, the cell identified by the information may be a cell with which the first node performs the signal reception and/or transmission.

Third carrier frequency indication information, which indicates the carrier frequency to which the information reported by the first node is directed. In an embodiment of the disclosure, the information indicates information on the carrier frequency of the cell (a candidate target cell) to which the first node may access. Further, the information may include at least one of: location indication information on a central carrier frequency and indication information on a frequency band range;

First measurement result information, which contains a measurement result of the signal measured by the first node. In an embodiment of the disclosure, the signal belongs to other cell (not the current serving cell or the current primary cell or the current special primary cell of the first node). The information includes at least one of:

RSRP of Layer 3;

RSRQ of Layer 3;

SINR of Layer 3;

RSRP of Layer 1;

RSRQ of Layer 1;

SINR of Layer 1;

CQI;

First length information on measurement duration, which indicates that a duration when the measurement result of the first node is equal to or greater than the above measurement result;

First measurement counting information, which indicates the number of times that the measurement result of the first node is equal to or greater than the above measurement result;

The first state report information, which indicates the state of the first node. The state can reflect the state of the first node performing the signal reception and/or transmission. The advantageous effect of the information is that the second node can determine the configuration for the first node, thereby reducing the interruption in the procedure of the first node accessing to other cell. In an embodiment of the disclosure, the state is obtained by the first node after the first node performs the signal reception and/or transmission by itself. In another embodiment of the disclosure, the state information is obtained by the first node after the first node performs the signal reception and/or transmission according to the configuration of the above operations 1-1 and/or 1-2. The information may indicate at least one of:

No cell/carrier frequency/node detected. Such a state identifies that the first node has not detected a cell/carrier frequency/node (such as failing to receive a signal on the cell/carrier frequency/node), wherein the cell can be a cell indicated by the above “second cell identity information”, the carrier frequency can be a carrier frequency indicated by the above “second indication information on carrier frequency”, and the node can be a node indicated by the above “second identity information of node”. In an implementation, when the first node is in this state, the second node will configure the measurement time for the first node so that the first node can discover the cell/carrier frequency/node;

Cell/carrier frequency/node detected. Such a state indicates that the first node discovers cell(s)/carrier frequency(s)/node(s). The cell can be a cell indicated by the above “second cell identity information”, the carrier frequency can be a carrier frequency indicated by the “second indication information on carrier frequency”, and the node can be a node indicated by the above “second identity information of node”. In an implementation, when the first node is in the state, the second node will configure the first node to continue the measurement;

Downlink first synchronization (or retaining downlink synchronization information (or quasi co-location (QCL) attribute information on reference signal). If downlink first synchronization information is retained, the information is obtained after the downlink synchronization is performed based on an SSB). Such a state indicates that the first node has received a downlink first synchronization signal, such as an SSB, a PSS, an SSS. In an implementation, when the first node is in this state, the second node will configure the first node to continue the downlink second synchronization and/or the uplink synchronization;

Downlink (second) synchronization (or retaining the downlink synchronization information (or quasi co-location (QCL) attribute information on reference signal). If information on the downlink second synchronization is retained, the information is obtained after the downlink synchronization is performed based on an SSB and a TRS). Such a state indicates that the first node has completed the downlink (second) synchronization, such as the downlink synchronization with the cell through the SSB and the TRS. In an implementation, when the first node is in this state, the second node will configure the first node to perform the uplink synchronization;

Uplink synchronization signal transmission. Such a state indicates that the first node has transmitted an uplink synchronization signal (such as a random access signal, an SRS signal, a newly defined uplink signal, or the like). Further, in order to describe the specific state of transmitting the uplink synchronization signal, one of the following information can be included to indicate the state: 1) power used to transmit the signal, 2) a sequence used to transmit the signal, 3) the number of times of transmitting the signal, 4) a beam used to transmit the signal, and 5) time since transmitting the uplink synchronization signal last time. In an implementation, when the first node is in this state, the second node will configure the timing advance required by the first node to access to the cell in order to complete the uplink synchronization;

Uplink synchronization. The state indicates that the first node has acquired the uplink synchronization. In an embodiment of the disclosure, the first node has acquired the uplink synchronization with another cell (which is not a serving cell or a primary cell or a special primary cell of the first node, but may be a cell to which the first node may access). In an implementation, when the first node is in this state, the second node may consider that the first node is able to access to other cell, and the second node may handover the first node to a node serving the other cell;

Duration of state. The information indicates the duration when the first node is in at least one of the above states. In an implementation, according to the time information, the second node can configure the time that the first node performs the signal reception and/or transmission. When the first node is in different states, the time length configured by the second node may be different. The configured time length decreases in an order of states “no cell/carrier frequency/node detected”, “cell/carrier frequency/node detected”, “downlink first synchronization”, “downlink (second) synchronization”, “uplink synchronization signal transmission” and “uplink synchronization”.

In an implementation, the above first report message is a control plane message, such as an RRC message (such as an RRC Measurement report message). In another implementation, the first report message is a message of the second protocol layer, such as an message of L2 layer (such as a control element of the MAC layer). In another implementation, the above first report message is a message of the first protocol layer, such as a message of L1 layer (such as a message of the physical layer, uplink control information, or the like).

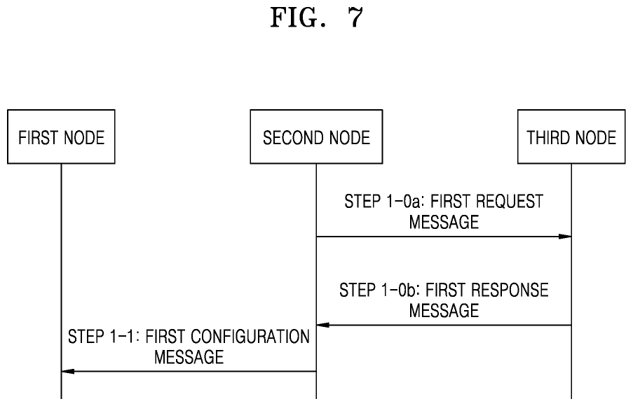

The above operations 1-1 and 1-2 are mainly used for configuring the first node to perform the signal reception and/or transmission. In an embodiment of the disclosure, the signal may belong to the serving cell (such as the primary cell, the primary secondary cell, or the secondary cell) of the first node. In another embodiment of the disclosure, the signal may belong to other cells, such as cells different from the serving cell for the first node. To achieve the configuration, the second node may need to obtain the configuration of the signal from other nodes, since the signal belongs to the cell served by other node. Therefore, optionally, before operation 1-1, the following steps may be included, as illustrated in FIG. 7:

FIG. 7 illustrates a third flow operation according to an embodiment of the disclosure.

Referring to FIG. 7, in operation 1-0a, the second node transmits a first request message to the third node, and the main function of the first request messages is to obtain the configuration required by the signal reception and/or transmission performed by the first node. The advantageous effect of the message is that the third node will configure the signal reception and/or transmission according to the state of the first node, thus reducing the time taken by the signal reception and/or transmission and accelerating access of the first node to a new cell. The message includes at least one of:

Fourth cell identity information, which indicates the cell to which the signal that the first node may receive and/or transmit belongs. In an embodiment of the disclosure, the cell may be a candidate target cell of the first node;

Fourth indication information on carrier frequency, which indicates a carrier frequency where the signal that the first node may receive and/or transmit is located. In an embodiment of the disclosure, the carrier frequency may be a carrier frequency where the candidate target cell of the first node is located;

Second measurement result information, which indicates the measurement result of the signal measured by the first node. The signal may be a signal of the cell identified by the above “fourth cell identity information” or a signal of the carrier frequency indicated by the above “fourth indication information on carrier frequency”. For the content included in the information, please refer to the description of the above “first measurement result information”. In an embodiment of the disclosure, the content in the information may be generated based on the first report message of the above operation 1-3;

Second state report information, which indicates the state of the first node. The second state report information can help the third node to generate the configuration required by the first node for the signal reception and/or transmission. For the content included in the information, please refer to the description of the above “first state report information”. In an embodiment of the disclosure, the content in the information may be generated based on the first report message of the above operation 1-3.

Operation 1-0b: The third node transmits a first response message to the second node. In order to help the first node access to the serving cell of the third node quickly, the third node may configure some resources for the first node receive and/or transmit a signal. On one hand, the first node may use signals on these resources to discover the cells served by the third node. On the other hand, the first node can also use these resources to perform an access. The response message includes configuration information which helps the access of the first node. The advantageous effect of the message is that the specific resources are configured to help the access of the first node, reducing the communication interruption in the access procedure and improving the communication performance (such as throughput, or the like) of the first node. The message includes at least one of:

Fifth cell identity information, which indicates a cell to which the signal that may be received and/or transmitted by the first node belongs. In an embodiment of the disclosure, the cell may be a candidate target cell of the first node;

Fifth indication information on carrier frequency, which indicates a carrier frequency where the first node may receive and/or transmit a signal. In an embodiment of the disclosure, the carrier frequency may be a carrier frequency of a candidate target cell of the first node;

Second configuration information on signal, which indicates the configuration information on the signal on the serving cell of the third node, and can be used for an access of the first node. In an embodiment of the disclosure, the configuration information is determined according to at least one of the “second measurement result information” and/or “second state report information” in operation 1-0a. For the contents included in the information, please refer to the above “first configuration information on signal”.

Second configuration information on signal reception and/or transmission, which indicates the configuration information used when transmitting and/or receiving the signal on the serving cell of the third node. In an embodiment of the disclosure, the configuration information is determined according to at least one of the “second measurement result information” and/or “second state report information” in operation 1-0a. For the contents included in the information, please refer to the above “first configuration information on signal reception and/or transmission”.

The third node determines the configuration required by the first node to receive and/or transmit a signal before accessing to the cell served by the third node according to the state of the first node, and the signal may be a newly defined signal or an existing signal. The third node will adjust the transmission or reception of the signal according to the state of the first node (for example, adjust the time for transmitting the downlink synchronization signal, adjust the time for receiving the uplink synchronization signal, and set the time for transmitting the downlink synchronization signal and the time for receiving the uplink synchronization signal to locations close to each other).

Optionally, operation 1-4: the first node transmits a first indication message to the second node or the third node. The first indication message is used to indicate the cell which is selected by the first node or to which the first node accesses. The advantageous effect of the message is that the network side can know the cell to which the first node accesses, so as to quickly start data transmission with the first node and reduce the interruption of data communication.

After defining the above steps, in order to realize that the first node access to a target cell quickly, there may be the following possible implementations.

### Implementation 1

The configuration information on the signal reception and/or transmission of the first node is obtained according to the measurement by the first node.

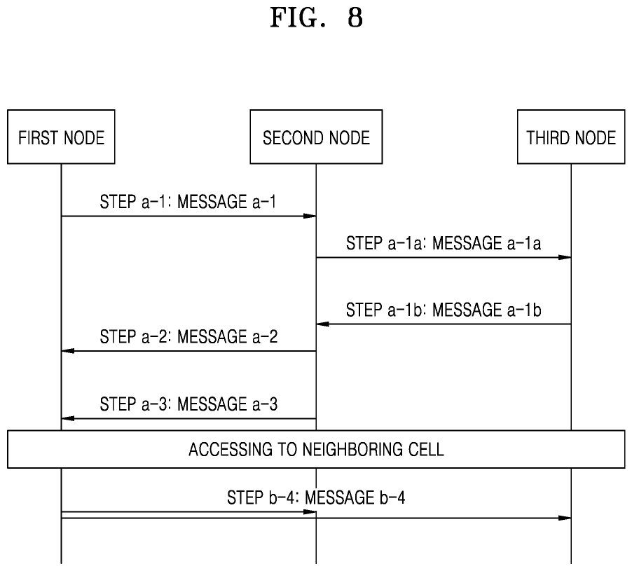

In this implementation, the first node may inform the second node of measurement result on neighboring nodes and/or neighboring cells and/or neighboring carrier frequencies, and then the second node determine the configuration of the first node for the signal reception and/or transmission according to the measurement result. This implementation includes the following steps, as illustrated in FIG. 8:

FIG. 8 illustrates a fourth flow operation according to an embodiment of the disclosure.

Referring to FIG. 8, in operation a-1, the first node transmits a message a-1 to the second node according to the measurement result, and the function of this message is to report the measurement result of the first node. For details, please refer to the above operation 1-3. For the message a-1, please refer to the above first report message.

Operation a-2: the second node transmits a message a-2 according to the received report information on the first node, and the message a-2 is used to configure the first node to perform the signal reception and/or transmission. For example, the second node may configure different time lengths according to different measurement results of the first node, so that the first node can perform the signal reception and/or transmission or uplink and downlink synchronization with the cell, or measurement on signals. For detailed description of this step, please refer to operation 1-1 above.

Between operations a-1 and a-2, an interaction procedure between the second node and the third node may also be included, namely:

Operation a-la: the second node transmits a message a-la to the third node, and the message a-la is used to request the third node to provide a signal received and/or transmitted by the first node, which belongs to the cell served by the third node. For detailed description of the step, please refer to the above operation 1-0a;

Operation a-1b: the third node transmits a message a-1b to the second node, and the message a-1b is used to provide, with the second node, a signal received and/or transmitted by the first node, which belongs to the cell served by the third node. For detailed description of the step, please refer to the above operation 1-0b.

Further, after operation a-2, operation a-3 is also included. The second node transmits a message a-3 to the first node. The step is mainly used to indicate the first node to perform the signal reception and/or transmission. For detailed content, please refer to the above operation 1-2. Optionally, after operation a-2, the second node may proceed to operation a-3 after receiving the measurement information (such as the information included in the above first report message) reported by the first node.

Further, after operation a-2, it can be further included that the first node can synchronize with a neighboring cell and access to the neighboring cell. After accessing to the neighboring cell, an operation a-4 is further included, in which the first node transmits a message a-4 to the second node or the third node, so as to inform the network (the second node or the third node) that the first node accesses to the cell. For details, please refer to the above operations 1-4.

### Implementation 2

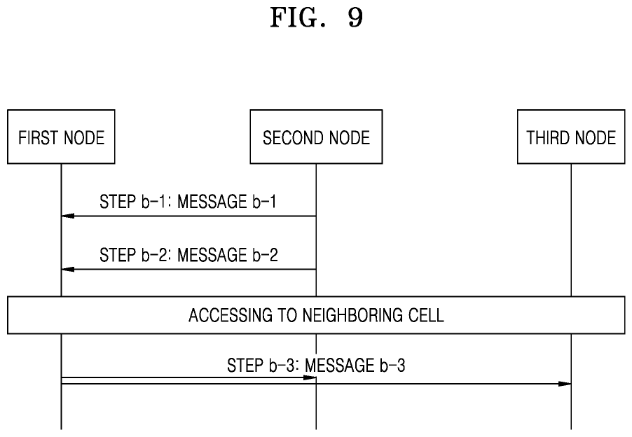

The first node performs a cell access according to the configuration of the second node, without the second node triggering the cell handover by the first node. In this embodiment of the disclosure, the first node decides to the cell handover by itself according to the configuration for receiving and/or transmitting the signal. This embodiment includes the following steps, as illustrated in FIG. 9:

FIG. 9 illustrates a fifth flow operation according to an embodiment of the disclosure.

Referring to FIG. 9, in operation b-1, the second node transmits a message b-1 to the first node, and the message b-1 is used to receive and/or transmit the configuration signal. This step can be referred to the above operation 1-1.

Before the operation b-1, it may also be included that an interaction flow between the second node and the third node (such as operations 1-0a and 1-0b above) for obtaining the configuration information in message b-1.

Optionally, when the above operation b-1 is used for configuration in advance, the operation b-2 may be further included, in which the second node transmits a message b-2 to the first node, that is, transmits, to the first node, indication information on the signal reception and/or transmission. For detailed description, please refer to the above operation 1-2.

After the above two steps, the first node can perform the signal reception and/or transmission of a neighboring cell by itself, according to the configuration in operations b-1 and/or b-2, thus completing the access to the neighboring cell. After accessing to the neighboring cell, operation b-3 may be further included, in which the first node transmits a message b-3 to the second node or the third node. The step is used to inform the network (the second node or the third node) that the first node accesses to the cell. For details, please refer to the above operation 1-4.

### Implementation 3

The second node indicates the cell handover based on the synchronization state of the first node.

Operation c-0: the second node transmits a configuration message to the first node, and the function of the configuration message is to configure the candidate cell of the handover for the first node, or to configure the first node to measure the candidate cell. Please refer to the above operation 1-1 for detailed description.

Operation c-1: the first node measures the candidate cell based on the configuration information of the second node. In this step, the first node may determine whether to store/retain (downlink, uplink, or downlink and uplink) synchronization information (or quasi co-location (QCL) attribute information of reference signal) in the following possible manners:

Manner 1: storing the synchronization information on the cell. For example, after the first node obtains the synchronization information on the candidate cell in the procedure of measuring the candidate cell, the first node stores the synchronization information on the cell. This manner has no restriction on the capability of the first node, such as no restriction on the number of cells to which the synchronization information stored by the first node belongs.

Manner 2: determining whether to store the synchronization information on the cell based on the configuration of the second node. In this manner, whether the first node needs to store the synchronization information on the candidate cell is indicated in operation c-0 (as indicated by “first indication information on behavior” in “first configuration information on signal reception and/or transmission” in operation 1-1). If it is indicated in operation c-0 that the information needs to be stored, the first node stores the synchronization information on the candidate cell after obtaining the synchronization information on the candidate cell in the procedure of measuring the candidate cell by the first node. This manner has no restriction on the capability of the first node, such as no restriction on the number of cells to which the synchronization information stored by the first node belongs.

Manner 3: storing the synchronization information on the indicated cell. For example, after obtaining the synchronization information on the candidate cell in the procedure of measuring the candidate cell by the first node, if it is indicated in operation c-0 that the first node needs to store the synchronization information on the candidate cell (for example, the synchronization information of which cells need to be stored by the first node is indicated by the “first indication information on behavior” and “first target indication information” in “first configuration information on signal reception and/or transmission” in operation 1-1), then the first node can store the synchronization information. Otherwise, the first node does not store the synchronization information. In this manner, the first node can only store the synchronization information on the cell which is selected by the second node.

Manner 4: storing the synchronization information on a cell that satisfy a certain condition. The condition can be configured by the second node for the first node (such as the condition configured by operation c-0, which can be the condition indicated by the “first condition indication information” in operation 1-1). In an embodiment of the disclosure, if the measurement result of a cell is greater than the threshold indicated by the “fifth threshold information” in the above operation 1-1, the first node stores the synchronization information on the cell. In an embodiment of the disclosure, if the number of cells to which the synchronization information stored by the first node belongs is less than the threshold indicated by the “fifth threshold information” in the above operation 1-1, the first node stores the synchronization information on the cell. In an embodiment of the disclosure, if the number of cells to which the synchronization information stored by the first node belongs is less than the threshold indicated by the “fifth threshold information” in the above operation 1-1 and the measurement result of the cell is greater than the threshold indicated by the “fifth threshold information” in the above operation 1-1, the first node stores the synchronization information on the cells. In an embodiment of the disclosure, if the number of cells to which the synchronization information stored by the first node belongs is equal to the threshold indicated by the “fifth threshold information” in the above operation 1-1 and the measurement result of the cell is greater than the threshold indicated by the “fifth threshold information” in the above operation 1-1, when the measurement results of the cells to which the synchronization information stored by the first node belongs are all greater than that of the cell, the first node will not store the synchronization information on the cell. While the measurement results of a portion of cells to which the synchronization information stored by the first node belongs are less than that of the cell, the first node stores the synchronization information on the cell and deletes the synchronization information on a cell (the cell is one of the cells to which the synchronization information stored by the first node belongs, such as the cell with the smallest measurement result).

Operation c-2: the first node reports the measurement result to the second node. For details, please refer to the description in operation 1-3 above. In an implementation, the first node can report the measurement result of any cell which is measured, and then the first node can inform the second node whether the synchronization information on the cell is stored through the reported measurement result (such as indicating whether the synchronization information on the cell is stored through the “first state report information” in the above operation 1-3). In another implementation, the first node can report the measurement result of the cell which is measured and of which the synchronization information is retained, and then the cell which is included in the measurement result reported in the step is the cell of which the synchronization information is retained by the first node.

Operation c-3: the second node indicates the behavior of the first node according to the reported measurement result. For details, please refer to the above operation 1-2. In an implementation, if the second node knows the cell of which the synchronization information is stored through operation c-2, the second node can trigger the first node to perform a random access to the cell through this step. For example, operation c-3 is that the second node triggers the first node performing the random access to the cell through the PDCCH. In an embodiment of the disclosure, the second node indicates the first node to handover to a cell, and the first node starts the handover procedure (downlink synchronization, uplink synchronization, or the like) after receiving the indication.

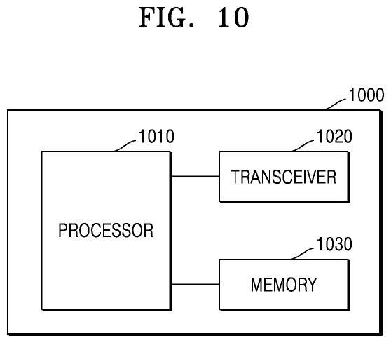

FIG. 10 is a block diagram of a network node in a network according to an embodiment of the disclosure.

The network node herein can be used to realize the first node, the second node or the third node in the disclosure.

Referring to FIG. 10, a network node according to the disclosure includes a processor 1010, a transceiver 1020, and a memory 1030. The transceiver 1020, the processor 1010 and the memory 1030 are configured to perform the operations of the methods and/or embodiments of the disclosure. However, all of the illustrated components are not essential. A network node 1000 may be implemented by more or less components than those illustrated in FIG. 10. In addition, the processor 1010 and the transceiver 1020 and the memory 1030 may be implemented as a single chip according to another embodiment. Although the processor 1010, the transceiver 1020, and the memory 1030 are illustrated as separate entities, they may be implemented as a single entity, such as a single chip. The processor 1010, the transceiver 1020, and the memory 1030 may be electrically connected or coupled to each other.

The transceiver 1020 can transmit and receive a signal to and from other network nodes, such as user terminal equipment, base stations or core network nodes. The processor 1010 may include one or more processing units and may control network nodes to perform operations and/or functions according to one of the above embodiments. The memory 1030 may store instructions for implementing operations and/or functions of one of the above embodiments.

The aforementioned components will be described below.

The processor 1010 may include one or more processors or other processing devices that control the proposed function, process, and/or method. Operation of the network node 1000 may be implemented by the processor 1010.

The transceiver 1020 may include a RF transmitter for up-converting and amplifying a transmitted signal, and a RF receiver for down-converting a frequency of a received signal. However, according to another embodiment of the disclosure, the transceiver 1020 may be implemented by more or less components than those illustrated in components.

The transceiver 1020 may be connected to the processor 1010 and transmit and/or receive a signal. The signal may include control information and data. In addition, the transceiver 1020 may receive the signal through a wireless channel and output the signal to the processor 1010. The transceiver 1020 may transmit a signal output from the processor 1010 through the wireless channel.

The memory 1030 may store the control information or the data included in a signal obtained by the network node 1000. The memory 1030 may be connected to the processor 1010 and store at least one instruction or a protocol or a parameter for the proposed function, process, and/or method. The memory 1030 may include a read-only memory (ROM) and/or a random access memory (RAM) and/or a hard disk and/or a compact disc (CD)-ROM and/or a digital versatile disc (DVD) and/or other storage devices.

When the network node is a first node, the network node may be a user terminal equipment, which can be a mobile phone or a relay node. The first node may include an antenna, a radio frequency (RF) transceiver, a transmission (TX) processing circuit, a microphone, and a reception (RX) processing circuit. The first node also includes a speaker, a processor/controller, an input/output (I/O) interface, an input device(s), a display, and a memory. The memory includes an operating system (OS) and one or more applications.

The RF transceiver receives an incoming RF signal transmitted by a gNB of the wireless network from the antenna. The RF transceiver down-converts the incoming RF signal to generate an intermediate frequency (IF) or baseband signal. The IF or baseband signal is transmitted to the RX processing circuit, where the RX processing circuit generates a processed baseband signal by filtering, decoding and/or digitizing the baseband or IF signal. The RX processing circuit transmits the processed baseband signal to speaker (such as for voice data) or to processor/controller for further processing (such as for web browsing data).

The TX processing circuit receives analog or digital voice data from microphone or other outgoing baseband data (such as network data, email or interactive video game data) from processor/controller. The TX processing circuit encodes, multiplexes, and/or digitizes the outgoing baseband data to generate a processed baseband or IF signal. The RF transceiver receives the outgoing processed baseband or IF signal from the TX processing circuit and up-converts the baseband or IF signal into an RF signal transmitted via the antenna.

The processor/controller can include one or more processors or other processing devices and execute an OS stored in the memory in order to control the overall operation of the first node. For example, the processor/controller can control the reception of forward channel signals and the transmission of backward channel signals through the RF transceiver, the RX processing circuit and the TX processing circuit according to well-known principles. In some embodiments of the disclosure, the processor/controller includes at least one microprocessor or microcontroller.

The processor/controller is also capable of executing other processes and programs residing in the memory, such as operations for channel quality measurement and reporting for systems with two-dimensional (2D) antenna arrays as described in embodiments of the disclosure. The processor/controller can move data into or out of the memory as required by an execution process. In some embodiments of the disclosure, the processor/controller is configured to execute the application based on the OS or in response to signals received from the gNB or the operator. The processor/controller is also coupled to an I/O interface, where the I/O interface provides the first node with the ability to connect to other devices, such as laptop computers and handheld computers. I/O interface is a communication path between these accessories and the processor/controller.

The processor/controller is also coupled to the input device(s) and the display. An operator of the first node can input data into first node using the input device(s). The display may be a liquid crystal display or other display capable of presenting text and/or at least limited graphics (such as from a website). The memory 360 is coupled to the processor/controller. A part of the memory can include a random access memory (RAM), while another part of the memory can include a flash memory or other read-only memory (ROM).

When the network node is a second node or a third node, the network node may be a base station or a first access point. The second node or the third node may include a plurality of antennas, a plurality of RF transceivers, a transmission (TX) processing circuit, and a reception (RX) processing circuit. In certain embodiments of the disclosure, one or more of the plurality of antennas include a 2D antenna array. The second node or the third node also includes a controller/processor, a memory, and a backhaul or network interface.

RF transceivers receive an incoming RF signal from antennas, such as a signal transmitted by other nodes. RF transceivers down-convert the incoming RF signal to generate an IF or baseband signal. The IF or baseband signal is transmitted to the RX processing circuit, where the RX processing circuit generates a processed baseband signal by filtering, decoding and/or digitizing the baseband or IF signal. RX processing circuit transmits the processed baseband signal to controller/processor for further processing.

The TX processing circuit receives analog or digital data (such as voice data, network data, email or interactive video game data) from the controller/processor. TX processing circuit encodes, multiplexes and/or digitizes outgoing baseband data to generate a processed baseband or IF signal. RF transceivers receive the outgoing processed baseband or IF signal from TX processing circuit and up-convert the baseband or IF signal into an RF signal transmitted via antennas.

The controller/processor can include one or more processors or other processing devices that control the overall operation of the second node or the third node. For example, the controller/processor can control the reception of forward channel signals and the transmission of backward channel signals through the RF transceivers, the RX processing circuit and the TX processing circuit according to well-known principles. The controller/processor can also support additional functions, such as higher-level wireless communication functions. For example, the controller/processor can perform a blind interference sensing (BIS) process, such as that performed through a BIS algorithm, and decode a received signal from which an interference signal is subtracted. A controller/processor may support any of a variety of other functions in the second node or the third node. In some embodiments of the disclosure, the controller/processor includes at least one microprocessor or microcontroller.

The controller/processor is also capable of executing programs and other processes residing in the memory, such as a basic OS. The controller/processor can also support channel quality measurement and reporting for systems with 2D antenna arrays as described in embodiments of the disclosure. In some embodiments of the disclosure, the controller/processor supports communication between entities, such as web real-time communications (RTCs). The controller/processor can move data into or out of the memory as required by an execution process.

The controller/processor is also coupled to the backhaul or network interface. The backhaul or network interface allows second node or third node to communicate with other devices or systems through a backhaul connection or through a network. The backhaul or network interface can support communication over any suitable wired or wireless connection(s). For example, when second node or third node is implemented as a part of a cellular communication system, such as a cellular communication system supporting 5G or new radio access technology or NR, LTE or LTE-advanced (LTE-A), the backhaul or network interface can allow second node or third node to communicate with other nodes through wired or wireless backhaul connections. When is implemented as an access point, the backhaul or network interface 382 can allow second node or third node to communicate with a larger network, such as the Internet, through a wired or wireless local area network or through a wired or wireless connection. The backhaul or network interface includes any suitable structure that supports communication through a wired or wireless connection, such as an Ethernet or an RF transceiver.

The memory is coupled to the controller/processor. A part of the memory can include a RAM, while another part of the memory can include a flash memory or other ROMs. In certain embodiments of the disclosure, a plurality of instructions, such as the BIS algorithm, are stored in the memory. The plurality of instructions are configured to cause the controller/processor to execute the BIS process and decode the received signal after subtracting at least one interference signal determined by the BIS algorithm.

As will be described below, the transmission and reception paths of gNB 102 (implemented using RF transceivers, TX processing circuit and/or RX processing circuit) support aggregated communication with frequency division duplex (FDD) cells and time division duplex (TDD) cells.

Although FIG. 10 illustrates an example of a network node, various changes may be made to FIG. 10. As a specific example, the access point can include many backhaul or network interfaces, and the controller/processor can support routing functions to route data between different network addresses. As another specific example, although shown as including a single instance of the TX processing circuit and a single instance of the RX processing circuit, gNB 102 can include multiple instances of each (such as one for each RF transceiver).

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

It should be understood that while the flow diagrams of embodiments of the disclosure indicate the individual operational steps by arrows, the order in which these steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the disclosure are not limited thereto.

While the disclosure has been shown and described with reference to various embodiments thereof, it will be understood by those skilled in the art that various changes in form and details may be made therein without departing from the spirt and scope of the disclosure as defined by the appended claims and their equivalents.

What is claimed is:

1. A method performed by a first node in a communication system, the method comprising:
transmitting a first message, to a second node, the first message including information related to a state in which the first node is;
receiving a second message, from the second node, the second message including first configuration information related to signal transmission or reception by the first node; and
transmitting and/or receiving a signal based on the first configuration information.

2. The method of claim 1, wherein the information related to the state in which the first node includes at least one of:
information identifying that the first node is in a state in which no cell/carrier frequency/node is detected;
information identifying that the first node is in a state in which a cell/carrier frequency/node is detected;
information indicating that the first node is in a state in which a downlink first synchronization signal has been received;
information indicating that the first node is in a state in which downlink synchronization has been completed;
information indicating that the first node is in a state in which an uplink synchronization signal is transmitted; or
information indicating that the first node is in a state in which an uplink synchronization is acquired.

3. The method of claim 1, wherein, the first configuration information related to the signal transmission or reception by the first node includes at least one of:
first configuration identity information for identifying a configuration required by the signal reception or transmission by the first node;
first target indication information for indicating a target to which a signal received or transmitted by the first node belongs;
first signal configuration information for indicating configuration information on a signal that the first node needs to receive or transmit;
first signal reception or transmission information for indicating configuration information required by the signal reception or transmission by the first node to receive or transmit a signal; or
first access information for indicating a configuration used by the first node when accessing to a target cell.

4. The method of claim 1, further comprising:
receiving a third message from the second node, the third message including second configuration information related to the signal transmission or reception by the first node,
wherein the signal transmission or reception includes the signal transmission or reception based on the first configuration information and the second configuration information.

5. The method of claim 1,
wherein, in response to the first message transmitted to the second node, a first request message including the information related to the state, in which the first node is, is transmitted from the second node to a third node, and
wherein a first response message including the first configuration information is transmitted from the third node to the second node.

6. The method of claim 3,
wherein the first target indication information includes at least one of:
information related to a node to which a signal received or transmitted by the first node belongs,
information related to a cell to which the signal received or transmitted by the first node belongs,
indication information related to a type of the cell to which the signal received or transmitted by the first node belongs, or
information indicating a carrier frequency where the signal received or transmitted by the first node is located,
wherein the first signal configuration information includes at least one of:
information identifying a set of configurations of the signal received or transmitted by the first node,
information indicating a type of the signal received or transmitted by the first node,
information indicating resources used for receiving or transmitting the signal,
cell timing information indicating a timing offset between different cells,
configuration information on beams required by the signal reception or transmission by the first node,
information on a sequence included in the signal received or transmitted by the first node,
information indicating a timing advance required when a user equipment (UE) transmits the signal, or
information indicating a valid time of configuration information included in the first configuration information on signal, and
wherein the first signal reception or transmission configuration information includes at least one of:
information identifying a set of configurations required by the signal reception or transmission by the first node,
information indicating a time range for the signal reception or transmission by first node,
information indicating behaviors of the first node,
information indicating a type of the signal received or transmitted by the first node, or
information indicating a condition for the signal reception or transmission by the first node.

7. The method of claim 4, wherein the second configuration information related to the signal transmission or reception by the first node includes at least one of:
related information indicating a configuration required by the signal reception or transmission by the first node;
related information indicating a node to which the signal received or transmitted by the first node belongs;
related information indicating a cell to which the signal received or transmitted by the first node belongs;
information indicating a carrier frequency to which the signal received or transmitted by the first node belongs;
information indicating a configuration for the signal received or transmitted by the first node;
related information indicating a configuration required by reception or transmission of the signal by the first node;
related information indicating a configuration required by the signal reception or transmission by the first node;
related information indicating a configuration required by a condition of the signal reception or transmission by the first node;
information indicating beams required by the signal reception or transmission by the first node; or
information indicating a timing advance required for transmitting an uplink signal.

8. A method performed by a second node in a communication system, the method comprising:
receiving a first message from a first node, the first message including information related to a state in which the first node is; and
transmitting a second message to the first node, the second message including first configuration information related to signal transmission or reception by the first node.

9. The method of claim 8, wherein the information related to the state in which the first node includes at least one of:
information identifying that the first node is in a state in which no cell/carrier frequency/node is detected;
information identifying that the first node is in a state in which a cell/carrier frequency/node is detected;
information indicating that the first node is in a state in which a downlink first synchronization signal has been received;
information indicating that the first node is in a state in which downlink synchronization has been completed;
information indicating that the first node is in a state in which an uplink synchronization signal is transmitted; or
information indicating that the first node is in a state in which uplink synchronization is acquired.

10. The method of claim 8, further comprising:
in response to the first message received from the first node, transmitting, to a third node, a first request message including the information related to the state in which the first node is; and
receiving a first response message including the first configuration information from the third node.

11. A method performed by a third node in a communication system, the method comprising:
receiving, from a second node, a first request message including information related to a state in which a first node is; and
transmitting, to the second node, a first response message including first configuration information related to signal transmission or reception performed at the first node.

12. The method of claim 11,
wherein the first request message is transmitted by the second node in response to receiving a first message from a first node, and
wherein the first message includes the information related to the state in which the first node is.

13. The method of claim 12,
wherein a second message is transmitted from the second node to the first node,
wherein the second message includes the first configuration information related to the signal transmission or reception performed at the first node, and
wherein the signal transmission or reception is performed by the first node based on the first configuration information.

14. The method of claim 13,
wherein a third message is transmitted from the second node to the first node,
wherein the third message includes second configuration information related to the signal transmission or reception performed at the first node, and
wherein, based on the first configuration information and the second configuration information, the signal transmission or reception is performed by the first node.

15. A network node in a communication system, the network node comprising:
a transceiver configured to transmit and receive a signal; and
a processor coupled with the transceiver and configured to:
transmit a first message, to a second node, the first message including information related to a state in which the first node is,
receive a second message, from the second node, the second message including first configuration information related to signal transmission or reception by the first node, and
transmit and/or receive a signal based on the first configuration information.

16. The network node of claim 15, wherein the information related to the state in which the first node includes at least one of:
information identifying that the first node is in a state in which no cell/carrier frequency/node is detected;
information identifying that the first node is in a state in which a cell/carrier frequency/node is detected;
information indicating that the first node is in a state in which a downlink first synchronization signal has been received;
information indicating that the first node is in a state in which downlink synchronization has been completed;
information indicating that the first node is in a state in which an uplink synchronization signal is transmitted; or
information indicating that the first node is in a state in which an uplink synchronization is acquired.

17. The network node of claim 15, wherein, the first configuration information related to the signal transmission or reception by the first node includes at least one of:
first configuration identity information for identifying a configuration required by the signal reception or transmission by the first node;
first target indication information for indicating a target to which a signal received or transmitted by the first node belongs;
first signal configuration information for indicating configuration information on a signal that the first node needs to receive or transmit;
first signal reception or transmission information for indicating configuration information required by the signal reception or transmission by the first node to receive or transmit a signal; or
first access information for indicating a configuration used by the first node when accessing to a target cell.

18. The network node of claim 15, further comprising:
receiving a third message from the second node, the third message including second configuration information related to the signal transmission or reception by the first node,
wherein the signal transmission or reception includes the signal transmission or reception based on the first configuration information and the second configuration information.

19. The network node of claim 17,
wherein, in response to the first message transmitted to the second node, a first request message including the information related to the state, in which the first node is, is transmitted from the second node to a third node, and
wherein a first response message including the first configuration information is transmitted from the third node to the second node.

20. The network node of claim 19,
wherein the first target indication information includes at least one of:
information related to a node to which a signal received or transmitted by the first node belongs,
information related to a cell to which the signal received or transmitted by the first node belongs,
indication information related to a type of the cell to which the signal received or transmitted by the first node belongs, or
information indicating a carrier frequency where the signal received or transmitted by the first node is located,
wherein the first signal configuration information includes at least one of:
information identifying a set of configurations of the signal received or transmitted by the first node,
information indicating a type of the signal received or transmitted by the first node,
information indicating resources used for receiving or transmitting the signal,
cell timing information indicating a timing offset between different cells, configuration information on beams required by the signal reception or transmission by the first node,
information on a sequence included in the signal received or transmitted by the first node,
information indicating a timing advance required when a user equipment (UE) transmits the signal, or
information indicating a valid time of configuration information included in the first configuration information on signal, and
wherein the first signal reception or transmission configuration information includes at least one of:
information identifying a set of configurations required by the signal reception or transmission by the first node,
information indicating a time range for the signal reception or transmission by first node,
information indicating behaviors of the first node,
information indicating a type of the signal received or transmitted by the first node, or
information indicating a condition for the signal reception or transmission by the first node.
